(19) United States
(12) Patent Application Publication
(10) Pub. No.: US 2018/0332012 A1
(43) Pub. Date: Nov. 15, 2018

(54) POST-COMPILATION CONFIGURATION MANAGEMENT

(71) Applicant: International Business Machines Corporation, Armonk, NY (US)

(72) Inventors: David M. Koster, Rochester, MN (US); Alexander Cook, Chaska, MN (US); Christopher R. Sabotta, Rochester, MN (US); Manuel Orozco, Rochester, MN (US)

(21) Appl. No.: 15/593,867

(22) Filed: May 12, 2017

(51) Int. Cl. H04L 29/06; G06F 21/60; H04L 9/08; H04L 29/08

(52) U.S. Cl. CPC H04L 63/0457; H04L 67/10; H04L 9/0819; G06F 21/602

(57) ABSTRACT

Disclosed aspects relate to post-compilation configuration management in a stream computing environment to process a stream of tuples. An escalation request may be detected pertaining to a post-compilation phase in the stream computing environment. The escalation request may relate to a requested computing configuration for a process in the stream computing environment. An appropriate computing configuration may be determined for the process in the stream computing environment. The appropriate computing configuration may be determined based on the requested computing configuration for the process in the stream computing environment. The appropriate computing configuration may be established using a containerization technique for the process in the stream computing environment.

### BACKGROUND

This disclosure relates generally to computer systems and, more particularly, relates to post-compilation configuration management in a stream computing environment to process a stream of tuples. The amount of data that needs to be managed by enterprises is increasing. Post-compilation configuration management may be desired to be performed as efficiently as possible. As data needing to be managed increases, the need for post-compilation configuration management may also increase.

### SUMMARY

Aspects of the disclosure relate to post-compilation configuration management in a stream computing environment to process a stream of tuples. A stream computing application may be partitioned to include both a privileged-segment and a user-segment to manage user process authorizations. Individual authorizations and permissions for the stream computing application may be managed on a process-by-process basis with respect to the stream computing environment. A request-based system may be utilized to provide individual capabilities to trusted portions of code prior to code execution. A container layer may be introduced between the stream computing application and a host operating system to deliver escalation requests to the host operating system without them originating from the stream computing application itself. Capabilities may be dynamically added and removed from the stream computing application prior to application runtime.

Disclosed aspects relate to post-compilation configuration management in a stream computing environment to process a stream of tuples. An escalation request may be detected pertaining to a post-compilation phase in the stream computing environment. The escalation request may relate to a requested computing configuration for a process in the stream computing environment. An appropriate computing configuration may be determined for the process in the stream computing environment. The appropriate computing configuration may be determined based on the requested computing configuration for the process in the stream computing environment. The appropriate computing configuration may be established using a containerization technique for the process in the stream computing environment.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a cloud computing node according to embodiments.

FIG. 2 depicts a cloud computing environment according to embodiments.

FIG. 3 depicts abstraction model layers according to embodiments.

FIG. 4 illustrates an exemplary computing infrastructure to execute a stream computing application according to embodiments.

FIG. 5 illustrates a view of a compute node according to embodiments.

FIG. 6 illustrates a view of a management system according to embodiments.

FIG. 7 illustrates a view of a compiler system according to embodiments.

FIG. 8 illustrates an exemplary operator graph for a stream computing application according to embodiments.

FIG. 9 is a flowchart illustrating a method for post-compilation configuration management in a stream computing environment to process a stream of tuples, according to embodiments.

FIG. 10 shows an example system for post-compilation configuration management in a stream computing environment to process a stream of tuples, according to embodiments.

FIG. 11 is a flowchart illustrating a method for post-compilation configuration management in a stream computing environment to process a stream of tuples, according to embodiments.

FIG. 12 is a flowchart illustrating a method for post-compilation configuration management in a stream computing environment to process a stream of tuples, according to embodiments.

FIG. 13 shows an example system for post-compilation configuration management in a stream computing environment to process a stream of tuples, according to embodiments.

FIG. 14 shows an example system for post-compilation configuration management in a stream computing environment to process a stream of tuples, according to embodiments.

FIG. 15 shows an example system for post-compilation configuration management in a stream computing environment to process a stream of tuples, according to embodiments.

FIG. 16 shows an example system for post-compilation configuration management in a stream computing environment to process a stream of tuples, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the disclosure relate to post-compilation configuration management in a stream computing environment to process a stream of tuples. A stream computing application may be partitioned to include both a privileged-segment (e.g., root area inaccessible to non-admin users) and a user-segment (e.g., general area accessible without special permissions) to manage user process authorizations. Individual authorizations and permissions for the stream computing application may be managed (e.g., escalated, revoked) on a process-by-process basis with respect to the stream computing environment. A request-based system may be utilized to provide individual capabilities (e.g., authorizations, permissions) to trusted portions of code prior to code execution. A container layer may be introduced between the stream computing application and a host operating system to deliver escalation requests to the host operating system without them originating from the stream computing application itself. Capabilities may be dynamically added and removed from the stream computing application prior to application runtime. Leveraging post-compilation configuration management with respect to a stream computing application may be associated with benefits such as data security, stream computing configuration flexibility, and stream computing application performance.

In a stream computing environment, stream computing applications may be associated with different sets of capabilities that govern the authorizations, access privileges, and behavior of associated user processes. Aspects of the disclosure relate to the recognition that, in some situations, capabilities for a stream computing application may be modified while user processes are running (e.g., at processing element startup), resulting in opportunities for exploitation as user processes are given administrator access to select their own capabilities. Accordingly, aspects of the disclosure relate to establishing a virtualized container layer between user processors and the host operating system to facilitate dynamic modification of capabilities of stream computing applications prior to code execution in the stream computing environment. The container layer may receive escalation requests from user processes, and individually determine appropriate capabilities for each user process. Validity windows may be established to set limits on how long and in what situations a particular user process has certain capabilities. As such, dynamic capability management with respect to a post-compilation stream computing environment may facilitate flexible and granular control of stream application behavior and promote efficient stream computing environment performance.

Stream-based computing and stream-based database computing are emerging as a developing technology for database systems. Products are available which allow users to create applications that process and query streaming data before it reaches a database file. With this emerging technology, users can specify processing logic to apply to inbound data records while they are “in flight,” with the results available in a very short amount of time, often in fractions of a second. Constructing an application using this type of processing has opened up a new programming paradigm that will allow for development of a broad variety of innovative applications, systems, and processes, as well as present new challenges for application programmers and database developers.

In a stream computing application, stream operators are connected to one another such that data flows from one stream operator to the next (e.g., over a TCP/IP socket). When a stream operator receives data, it may perform operations, such as analysis logic, which may change the tuple by adding or subtracting attributes, or updating the values of existing attributes within the tuple. When the analysis logic is complete, a new tuple is then sent to the next stream operator. Scalability is achieved by distributing an application across nodes by creating executables (i.e., processing elements), as well as replicating processing elements on multiple nodes and load balancing among them. Stream operators in a stream computing application can be fused together to form a processing element that is executable. Doing so allows processing elements to share a common process space, resulting in much faster communication between stream operators than is available using inter-process communication techniques (e.g., using a TCP/IP socket). Further, processing elements can be inserted or removed dynamically from an operator graph representing the flow of data through the stream computing application. A particular stream operator may not reside within the same operating system process as other stream operators. In addition, stream operators in the same operator graph may be hosted on different nodes, e.g., on different compute nodes or on different cores of a compute node.

Data flows from one stream operator to another in the form of a “tuple.” A tuple is a sequence of one or more attributes associated with an entity. Attributes may be any of a variety of different types, e.g., integer, float, Boolean, string, etc. The attributes may be ordered. In addition to attributes associated with an entity, a tuple may include metadata, i.e., data about the tuple. A tuple may be extended by adding one or more additional attributes or metadata to it. As used herein, “stream” or “data stream” refers to a sequence of tuples. Generally, a stream may be considered a pseudo-infinite sequence of tuples.

Tuples are received and output by stream operators and processing elements. An input tuple corresponding with a particular entity that is received by a stream operator or processing element, however, is generally not considered to be the same tuple that is output by the stream operator or processing element, even if the output tuple corresponds with the same entity or data as the input tuple. An output tuple need not be changed in some way from the input tuple.

Nonetheless, an output tuple may be changed in some way by a stream operator or processing element. An attribute or metadata may be added, deleted, or modified. For example, a tuple will often have two or more attributes. A stream operator or processing element may receive the tuple having multiple attributes and output a tuple corresponding with the input tuple. The stream operator or processing element may only change one of the attributes so that all of the attributes of the output tuple except one are the same as the attributes of the input tuple.

Generally, a particular tuple output by a stream operator or processing element may not be considered to be the same tuple as a corresponding input tuple even if the input tuple is not changed by the processing element. However, to simplify the present description and the claims, an output tuple that has the same data attributes or is associated with the same entity as a corresponding input tuple will be referred to herein as the same tuple unless the context or an express statement indicates otherwise.

Stream computing applications handle massive volumes of data that need to be processed efficiently and in real time. For example, a stream computing application may continuously ingest and analyze hundreds of thousands of messages per second and up to petabytes of data per day. Accordingly, each stream operator in a stream computing application may be required to process a received tuple within fractions of a second. Unless the stream operators are located in the same processing element, it is necessary to use an inter-process communication path each time a tuple is sent from one stream operator to another. Inter-process communication paths can be a critical resource in a stream computing application. According to various embodiments, the available bandwidth on one or more inter-process communication paths may be conserved. Efficient use of inter-process communication bandwidth can speed up processing.

A streams processing job has a directed graph of processing elements that send data tuples between the processing elements. The processing element operates on the incoming tuples, and produces output tuples. A processing element has an independent processing unit and runs on a host. The streams platform can be made up of a collection of hosts that are eligible for processing elements to be placed upon. When a job is submitted to the streams run-time, the platform scheduler processes the placement constraints on the processing elements, and then determines (the best) one of these candidates host for (all) the processing elements in that job, and schedules them for execution on the decided host.

Aspects of the disclosure include a method, system, and computer program product for post-compilation configuration management in a stream computing environment to process a stream of tuples. An escalation request may be detected pertaining to a post-compilation phase in the stream computing environment. The escalation request may relate to a requested computing configuration for a process in the stream computing environment. An appropriate computing configuration may be determined for the process in the stream computing environment. The appropriate computing configuration may be determined based on the requested computing configuration for the process in the stream computing environment. The appropriate computing configuration may be established using a containerization technique for the process in the stream computing environment.

In embodiments, the stream computing application may be partitioned using a containerization technique to have a set of computing objects including both a first subset of the set of computing objects related to a privileged-segment and a second subset of the set of computing objects related to a user-segment. The appropriate computing configuration may be established for the process in the stream computing environment pertaining to a run-time phase of the stream computing application. In embodiments, an escalation request relating to a requested computing capability, requested computing permission, requested file system access authority, requested physical resource utilization authority, requested encrypted-data access authority, or a requested computing resource allotment may be detected for the process in the stream computing environment pertaining to the post-compilation phase in the stream computing environment. Based on the escalation request, an appropriate computing capability, appropriate computing permission, appropriate file system access authority, appropriate physical resource utilization authority, appropriate encrypted-data access authority, or appropriate computing resource allotment may be determined and established for the process in the stream computing environment using the containerization technique. Altogether, performance or efficiency benefits with respect to operation efficiency in a distributed batch data processing environment may occur. Aspects may save resources such as bandwidth, processing, or memory.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

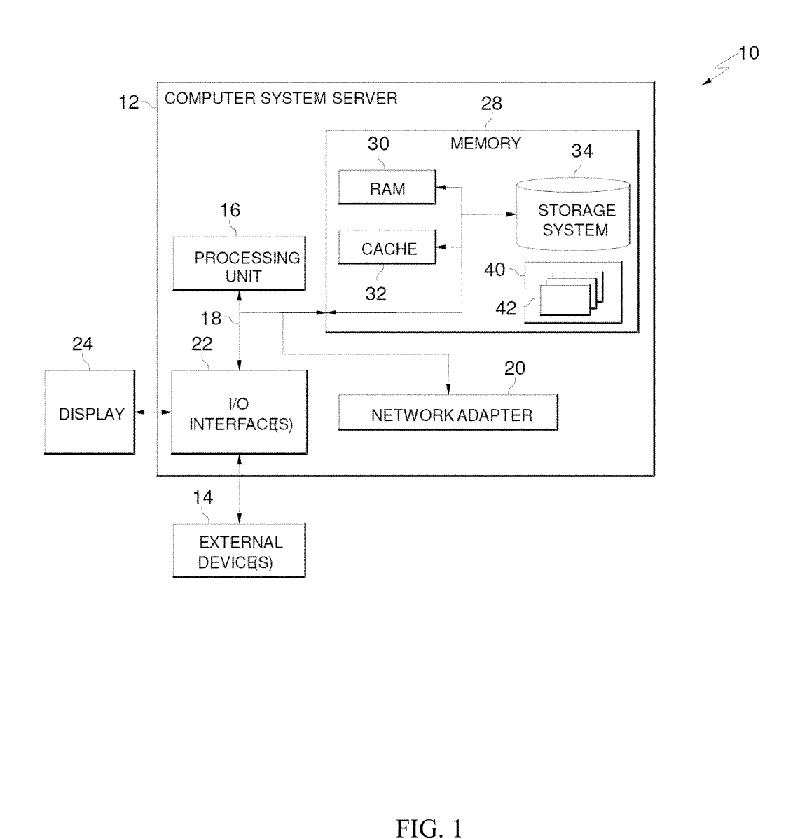

Referring now to FIG. 1, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

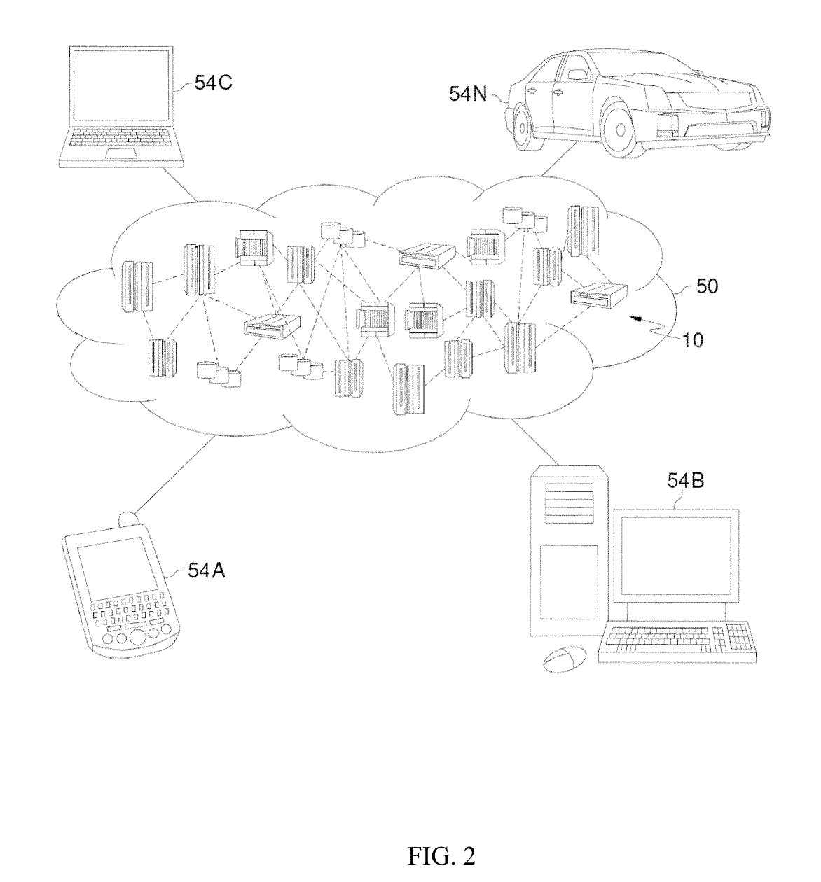

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

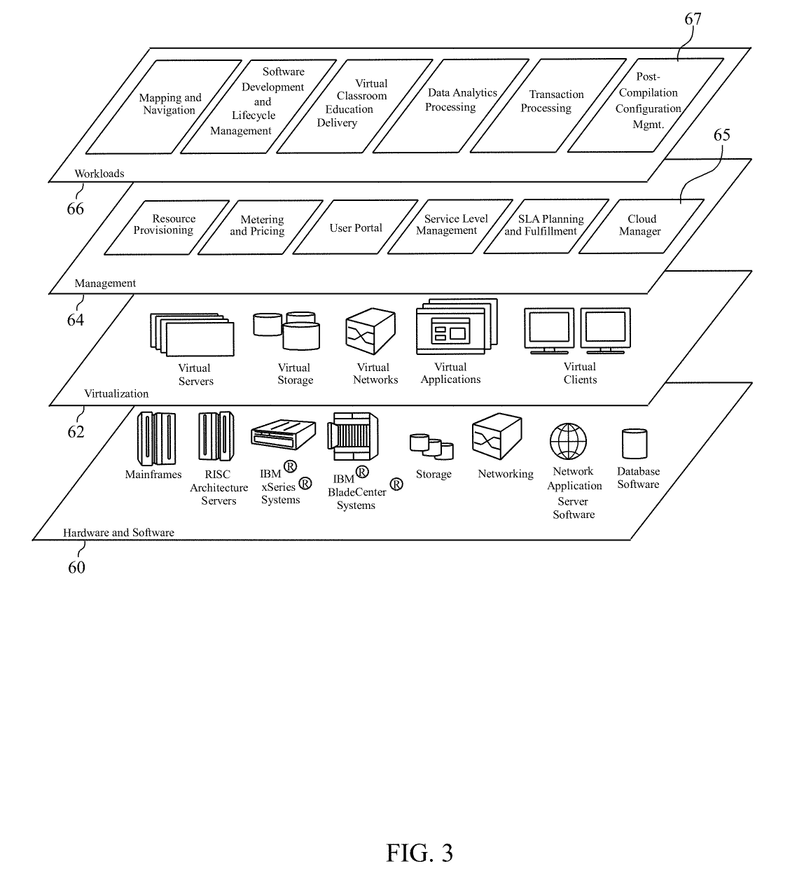

Referring now to FIG. 3, a set of functional abstraction layers provided by cloud computing environment 50 in FIG. 2 is shown. It should be understood in advance that the components, layers, and functions shown in FIG. 3 are intended to be illustrative only and the disclosure and claims are not limited thereto. As depicted, the following layers and corresponding functions are provided.

Hardware and software layer 60 includes hardware and software components. Examples of hardware components include mainframes; RISC (Reduced Instruction Set Computer) architecture based servers; storage devices; networks and networking components. Examples of software components include network application server software; database software; and streaming software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A cloud manager 65 is representative of a cloud manager (or shared pool manager) as described in more detail below. While the cloud manager 65 is shown in FIG. 3 to reside in the management layer 64, cloud manager 65 can span all of the levels shown in FIG. 3, as discussed below.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and post-compilation configuration management 67, which may be utilized as discussed in more detail below.

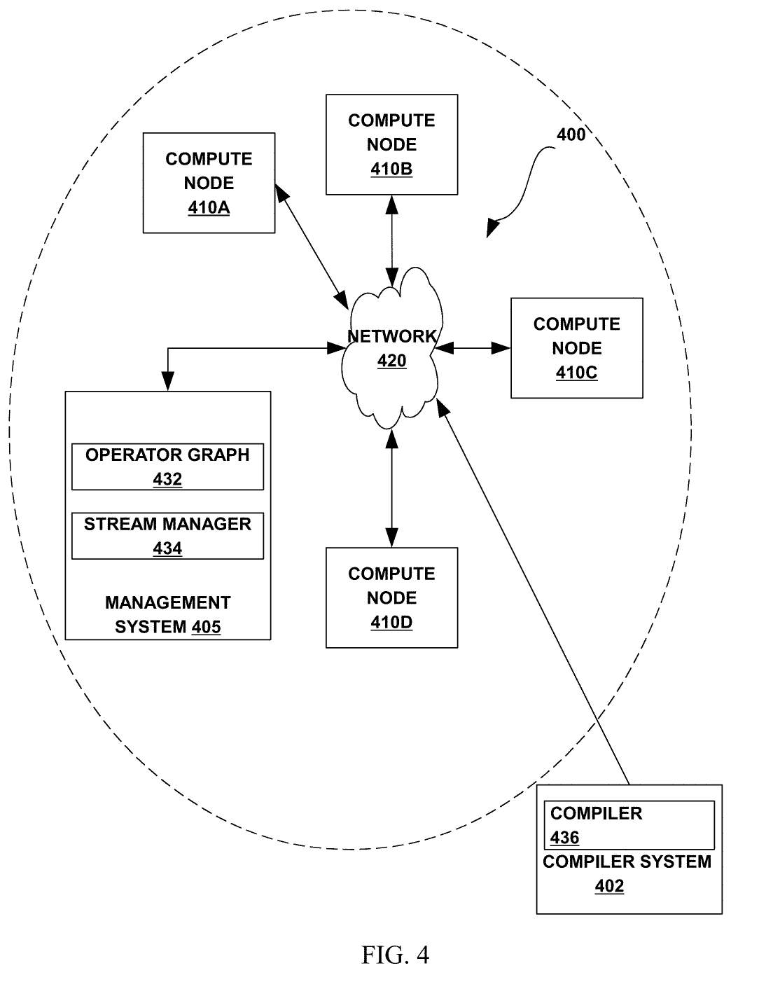

FIG. 4 illustrates one exemplary computing infrastructure 400 that may be configured to execute a stream computing application, according to some embodiments. The computing infrastructure 400 includes a management system 405 and two or more compute nodes 410A-410D—i.e., hosts—which are communicatively coupled to each other using one or more communications networks 420. The communications network 420 may include one or more servers, networks, or databases, and may use a particular communication protocol to transfer data between the compute nodes 410A-410D. A compiler system 402 may be communicatively coupled with the management system 405 and the compute nodes 410 either directly or via the communications network 420.

The communications network 420 may include a variety of types of physical communication channels or “links.” The links may be wired, wireless, optical, or any other suitable media. In addition, the communications network 420 may include a variety of network hardware and software for performing routing, switching, and other functions, such as routers, switches, or bridges. The communications network 420 may be dedicated for use by a stream computing application or shared with other applications and users. The communications network 420 may be any size. For example, the communications network 420 may include a single local area network or a wide area network spanning a large geographical area, such as the Internet. The links may provide different levels of bandwidth or capacity to transfer data at a particular rate. The bandwidth that a particular link provides may vary depending on a variety of factors, including the type of communication media and whether particular network hardware or software is functioning correctly or at full capacity. In addition, the bandwidth that a particular link provides to a stream computing application may vary if the link is shared with other applications and users. The available bandwidth may vary depending on the load placed on the link by the other applications and users. The bandwidth that a particular link provides may also vary depending on a temporal factor, such as time of day, day of week, day of month, or season.

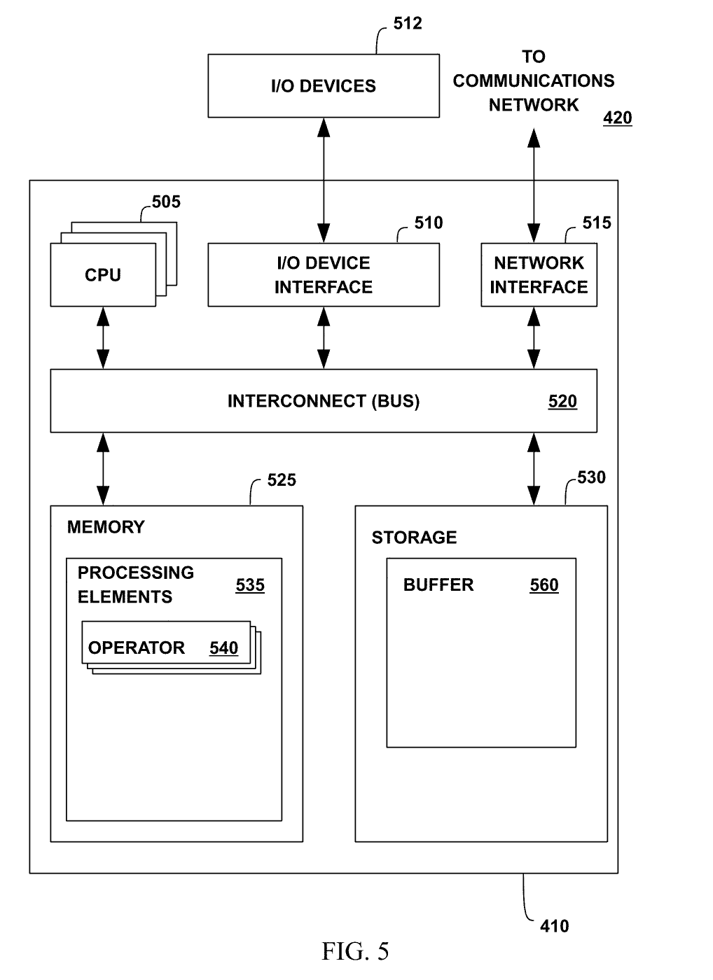

FIG. 5 is a more detailed view of a compute node 410, which may be the same as one of the compute nodes 410A-410D of FIG. 4, according to various embodiments. The compute node 410 may include, without limitation, one or more processors (CPUs) 505, a network interface 515, an interconnect 520, a memory 525, and a storage 530. The compute node 410 may also include an I/O device interface 510 used to connect I/O devices 512, e.g., keyboard, display, and mouse devices, to the compute node 410.

Each CPU 505 retrieves and executes programming instructions stored in the memory 525 or storage 530. Similarly, the CPU 505 stores and retrieves application data residing in the memory 525. The interconnect 520 is used to transmit programming instructions and application data between each CPU 505, I/O device interface 510, storage 530, network interface 515, and memory 525. The interconnect 520 may be one or more busses. The CPUs 505 may be a single CPU, multiple CPUs, or a single CPU having multiple processing cores in various embodiments. In one embodiment, a processor 505 may be a digital signal processor (DSP). One or more processing elements 535 (described below) may be stored in the memory 525. A processing element 535 may include one or more stream operators 540 (described below). In one embodiment, a processing element 535 is assigned to be executed by only one CPU 505, although in other embodiments the stream operators 540 of a processing element 535 may include one or more threads that are executed on two or more CPUs 505. The memory 525 is generally included to be representative of a random access memory, e.g., Static Random Access Memory (SRAM), Dynamic Random Access Memory (DRAM), or Flash. The storage 530 is generally included to be representative of a non-volatile memory, such as a hard disk drive, solid state device (SSD), or removable memory cards, optical storage, flash memory devices, network attached storage (NAS), or connections to storage area network (SAN) devices, or other devices that may store non-volatile data. The network interface 515 is configured to transmit data via the communications network 420.

A stream computing application may include one or more stream operators 540 that may be compiled into a “processing element” container 535. The memory 525 may include two or more processing elements 535, each processing element having one or more stream operators 540. Each stream operator 540 may include a portion of code that processes tuples flowing into a processing element and outputs tuples to other stream operators 540 in the same processing element, in other processing elements, or in both the same and other processing elements in a stream computing application. Processing elements 535 may pass tuples to other processing elements that are on the same compute node 410 or on other compute nodes that are accessible via communications network 420. For example, a processing element 535 on compute node 410A may output tuples to a processing element 535 on compute node 410B.

The storage 530 may include a buffer 560. Although shown as being in storage, the buffer 560 may be located in the memory 525 of the compute node 410 or in a combination of both memories. Moreover, storage 530 may include storage space that is external to the compute node 410, such as in a cloud.

The compute node 410 may include one or more operating systems. An operating system may be stored partially in memory 525 and partially in storage 530. Alternatively, an operating system may be stored entirely in memory 525 or entirely in storage 530. The operating system provides an interface between various hardware resources, including the CPU 505, and processing elements and other components of the stream computing application. In addition, an operating system provides common services for application programs, such as providing a time function.

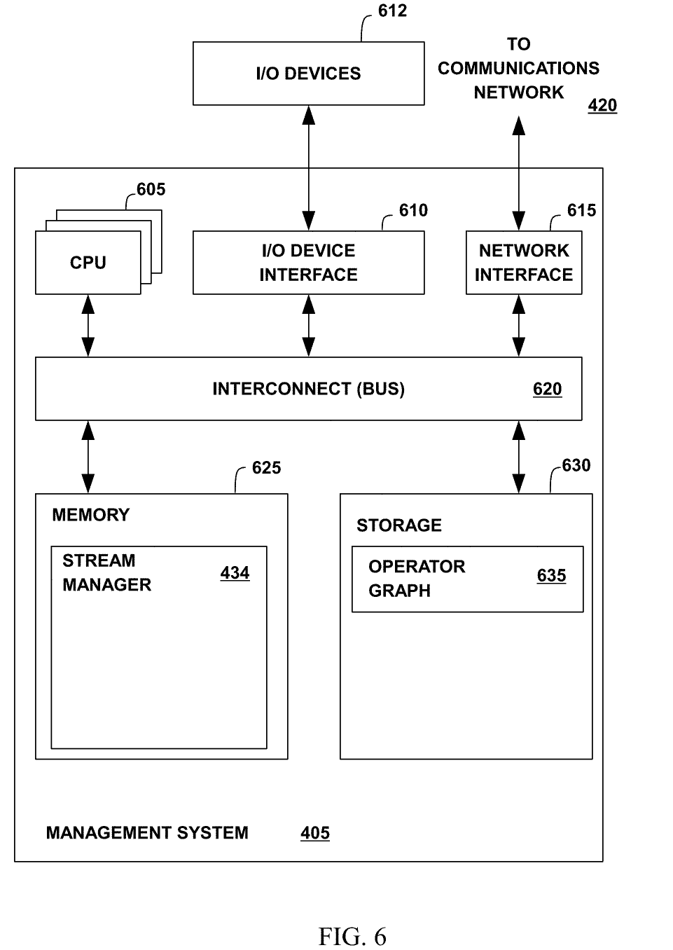

FIG. 6 is a more detailed view of the management system 405 of FIG. 4 according to some embodiments. The management system 405 may include, without limitation, one or more processors (CPUs) 605, a network interface 615, an interconnect 620, a memory 625, and a storage 630. The management system 405 may also include an I/O device interface 610 connecting I/O devices 612, e.g., keyboard, display, and mouse devices, to the management system 405.

Each CPU 605 retrieves and executes programming instructions stored in the memory 625 or storage 630. Similarly, each CPU 605 stores and retrieves application data residing in the memory 625 or storage 630. The interconnect 620 is used to move data, such as programming instructions and application data, between the CPU 605, I/O device interface 610, storage unit 630, network interface 615, and memory 625. The interconnect 620 may be one or more busses. The CPUs 605 may be a single CPU, multiple CPUs, or a single CPU having multiple processing cores in various embodiments. In one embodiment, a processor 605 may be a DSP. Memory 625 is generally included to be representative of a random access memory, e.g., SRAM, DRAM, or Flash. The storage 630 is generally included to be representative of a non-volatile memory, such as a hard disk drive, solid state device (SSD), removable memory cards, optical storage, Flash memory devices, network attached storage (NAS), connections to storage area-network (SAN) devices, or the cloud. The network interface 615 is configured to transmit data via the communications network 420.

The memory 625 may store a stream manager 434. Additionally, the storage 630 may store an operator graph 635. The operator graph 635 may define how tuples are routed to processing elements 535 (FIG. 5) for processing or stored in memory 625 (e.g., completely in embodiments, partially in embodiments).

The management system 405 may include one or more operating systems. An operating system may be stored partially in memory 625 and partially in storage 630. Alternatively, an operating system may be stored entirely in memory 625 or entirely in storage 630. The operating system provides an interface between various hardware resources, including the CPU 605, and processing elements and other components of the stream computing application. In addition, an operating system provides common services for application programs, such as providing a time function.

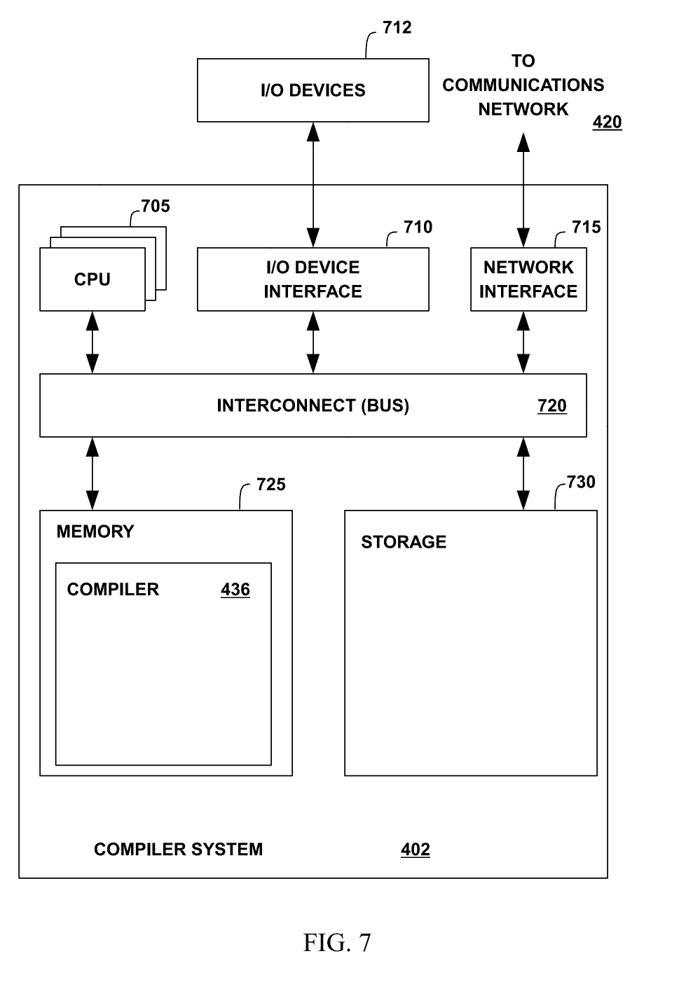

FIG. 7 is a more detailed view of the compiler system 402 of FIG. 4 according to some embodiments. The compiler system 402 may include, without limitation, one or more processors (CPUs) 705, a network interface 715, an interconnect 720, a memory 725, and storage 730. The compiler system 402 may also include an I/O device interface 710 connecting I/O devices 712, e.g., keyboard, display, and mouse devices, to the compiler system 402.

Each CPU 705 retrieves and executes programming instructions stored in the memory 725 or storage 730. Similarly, each CPU 705 stores and retrieves application data residing in the memory 725 or storage 730. The interconnect 720 is used to move data, such as programming instructions and application data, between the CPU 705, I/O device interface 710, storage unit 730, network interface 715, and memory 725. The interconnect 720 may be one or more busses. The CPUs 705 may be a single CPU, multiple CPUs, or a single CPU having multiple processing cores in various embodiments. In one embodiment, a processor 705 may be a DSP. Memory 725 is generally included to be representative of a random access memory, e.g., SRAM, DRAM, or Flash. The storage 730 is generally included to be representative of a non-volatile memory, such as a hard disk drive, solid state device (SSD), removable memory cards, optical storage, flash memory devices, network attached storage (NAS), connections to storage area-network (SAN) devices, or to the cloud. The network interface 715 is configured to transmit data via the communications network 420.

The compiler system 402 may include one or more operating systems. An operating system may be stored partially in memory 725 and partially in storage 730. Alternatively, an operating system may be stored entirely in memory 725 or entirely in storage 730. The operating system provides an interface between various hardware resources, including the CPU 705, and processing elements and other components of the stream computing application. In addition, an operating system provides common services for application programs, such as providing a time function.

The memory 725 may store a compiler 436. The compiler 436 compiles modules, which include source code or statements, into the object code, which includes machine instructions that execute on a processor. In one embodiment, the compiler 436 may translate the modules into an intermediate form before translating the intermediate form into object code. The compiler 436 may output a set of deployable artifacts that may include a set of processing elements and an application description language file (ADL file), which is a configuration file that describes the stream computing application. In some embodiments, the compiler 436 may be a just-in-time compiler that executes as part of an interpreter. In other embodiments, the compiler 436 may be an optimizing compiler. In various embodiments, the compiler 436 may perform peephole optimizations, local optimizations, loop optimizations, inter-procedural or whole-program optimizations, machine code optimizations, or any other optimizations that reduce the amount of time required to execute the object code, to reduce the amount of memory required to execute the object code, or both. The output of the compiler 436 may be represented by an operator graph (e.g., the operator graph 635 of FIG. 6).

The compiler 436 may also provide the application administrator with the ability to optimize performance through profile-driven fusion optimization. Fusing operators may improve performance by reducing the number of calls to a transport. While fusing stream operators may provide faster communication between operators than is available using inter-process communication techniques, any decision to fuse operators requires balancing the benefits of distributing processing across multiple compute nodes with the benefit of faster inter-operator communications. The compiler 436 may automate the fusion process to determine how to best fuse the operators to be hosted by one or more processing elements, while respecting user-specified constraints. This may be a two-step process, including compiling the application in a profiling mode and running the application, then re-compiling and using the optimizer during this subsequent compilation. The end result may, however, be a compiler-supplied deployable application with an optimized application configuration.

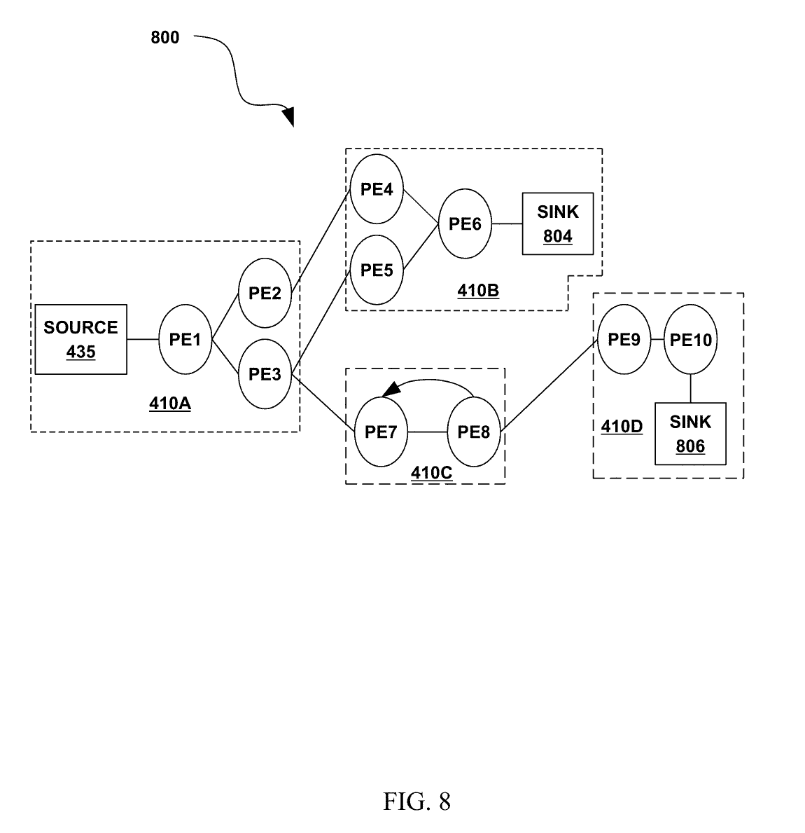

FIG. 8 illustrates an exemplary operator graph 800 for a stream computing application beginning from one or more sources 435 through to one or more sinks 804, 806, according to some embodiments. This flow from source to sink may also be generally referred to herein as an execution path. In addition, a flow from one processing element to another may be referred to as an execution path in various contexts. Although FIG. 8 is abstracted to show connected processing elements PE1-PE10, the operator graph 800 may include data flows between stream operators 540 (FIG. 5) within the same or different processing elements. Typically, processing elements, such as processing element 535 (FIG. 5), receive tuples from the stream as well as output tuples into the stream (except for a sink—where the stream terminates, or a source—where the stream begins). While the operator graph 800 includes a relatively small number of components, an operator graph may be much more complex and may include many individual operator graphs that may be statically or dynamically linked together.

The example operator graph shown in FIG. 8 includes ten processing elements (labeled as PE1-PE10) running on the compute nodes 410A-410D. A processing element may include one or more stream operators fused together to form an independently running process with its own process ID (PID) and memory space. In cases where two (or more) processing elements are running independently, inter-process communication may occur using a “transport,” e.g., a network socket, a TCP/IP socket, or shared memory. Inter-process communication paths used for inter-process communications can be a critical resource in a stream computing application. However, when stream operators are fused together, the fused stream operators can use more rapid communication techniques for passing tuples among stream operators in each processing element.

The operator graph 800 begins at a source 435 and ends at a sink 804, 806. Compute node 410A includes the processing elements PE1, PE2, and PE3. Source 435 flows into the processing element PE1, which in turn outputs tuples that are received by PE2 and PE3. For example, PE1 may split data attributes received in a tuple and pass some data attributes in a new tuple to PE2, while passing other data attributes in another new tuple to PE3. As a second example, PE1 may pass some received tuples to PE2 while passing other tuples to PE3. Tuples that flow to PE2 are processed by the stream operators contained in PE2, and the resulting tuples are then output to PE4 on compute node 410B. Likewise, the tuples output by PE4 flow to operator sink PE6 804. Similarly, tuples flowing from PE3 to PE5 also reach the operators in sink PE6 804. Thus, in addition to being a sink for this example operator graph, PE6 could be configured to perform a join operation, combining tuples received from PE4 and PE5. This example operator graph also shows tuples flowing from PE3 to PE7 on compute node 410C, which itself shows tuples flowing to PE8 and looping back to PE7. Tuples output from PE8 flow to PE9 on compute node 410D, which in turn outputs tuples to be processed by operators in a sink processing element, for example PE10 806.

Processing elements 535 (FIG. 5) may be configured to receive or output tuples in various formats, e.g., the processing elements or stream operators could exchange data marked up as XML documents. Furthermore, each stream operator 540 within a processing element 535 may be configured to carry out any form of data processing functions on received tuples, including, for example, writing to database tables or performing other database operations such as data joins, splits, reads, etc., as well as performing other data analytic functions or operations.

The stream manager 434 of FIG. 4 may be configured to monitor a stream computing application running on compute nodes, e.g., compute nodes 410A-410D, as well as to change the deployment of an operator graph, e.g., operator graph 432. The stream manager 434 may move processing elements from one compute node 410 to another, for example, to manage the processing loads of the compute nodes 410A-410D in the computing infrastructure 400. Further, stream manager 434 may control the stream computing application by inserting, removing, fusing, un-fusing, or otherwise modifying the processing elements and stream operators (or what tuples flow to the processing elements) running on the compute nodes 410A-410D.

Because a processing element may be a collection of fused stream operators, it is equally correct to describe the operator graph as one or more execution paths between specific stream operators, which may include execution paths to different stream operators within the same processing element. FIG. 8 illustrates execution paths between processing elements for the sake of clarity.

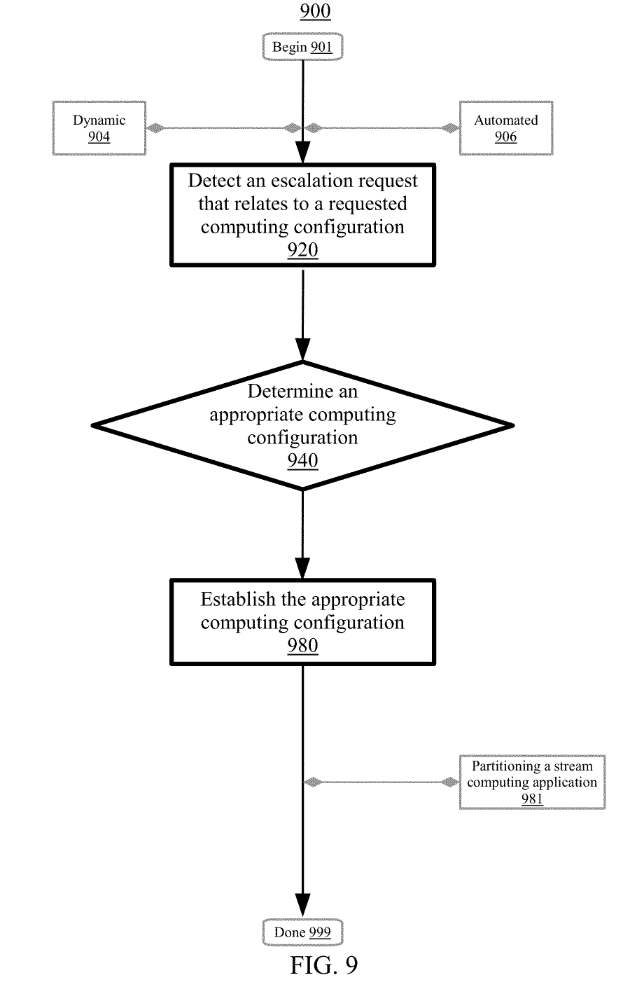

FIG. 9 is a flowchart illustrating a method 900 for post-compilation configuration management in a stream computing environment to process a stream of tuples, according to embodiments. Aspects of FIG. 9 relate to determining and establishing an appropriate computing configuration for a process in a stream computing environment based on an escalation request. The stream computing environment may include a platform for dynamically delivering and analyzing data in real-time. The stream computing environment may include an operator graph having a plurality of stream operators (e.g., filter operations, sort operators, join operators) and processing elements configured to perform processing operations on tuples flowing through the operator graph. The stream computing environment may facilitate execution and maintenance of one or more stream computing applications that run on one or more hosts (e.g., physical hardware or virtualized environments). In embodiments, stream computing applications may include one or more processes. Generally, a process may include an instance of the stream computing application that is configured to perform a task, function, or set of instructions within the stream computing environment. As examples, the process may include one or more user processes such as a memory read operation to fetch data from main memory, a write operation to store data to a database, a compression operation to compress data for transmission, an encryption operation to generate a hash to protect a set of data, or the like. As described herein, aspects of the disclosure relate to managing escalation requests to establish computing configurations for processes in the stream computing environment. Altogether, leveraging post-compilation configuration management with respect to a stream computing application may be associated with benefits such as data security, stream computing configuration flexibility, and stream computing application performance. The method 900 may begin at block 901.

In embodiments, the detecting, the determining, the establishing, and the other steps described herein may each be executed in a dynamic fashion at block 904. The executing may be performed in a dynamic fashion to streamline post-compilation configuration management in the stream computing environment. For instance, the detecting, the determining, the establishing, and the other steps described herein may occur in real-time, ongoing, or on-the-fly. As an example, one or more steps described herein may be performed in real-time (e.g., appropriate computing configurations may be dynamically determined and established in response to detecting escalation requests that indicate requested computing configurations for processes in the stream computing environment) in order to streamline (e.g., facilitate, promote, enhance) post-compilation configuration management in the stream computing environment to process the stream of tuples. Other methods of performing the steps described herein are also possible.

In embodiments, the detecting, the determining, the establishing, and the other steps described herein may each be executed in an automated fashion at block 906. The executing may be performed in an automated fashion without user intervention. In embodiments, the detecting, the determining, the establishing, and the other steps described herein may be carried-out by an internal post-compilation configuration management module maintained in a persistent storage device of a local computing device (e.g., network node). In embodiments, the detecting, the determining, the establishing, and the other steps described herein may be carried-out by an external post-compilation configuration management module hosted by a remote computing device or server (e.g., server accessible via a subscription, usage-based, or other service model). In this way, aspects of post-compilation configuration management in a stream computing environment to process a stream of tuples may be performed using automated computing machinery without manual action. Other methods of performing the steps described herein are also possible.

At block 920, an escalation request may be detected. The escalation request may pertain to a post-compilation phase in the stream computing environment. The escalation request may relate to a requested computing configuration for a process in the stream computing environment. Generally, detecting can include sensing, discovering, collecting, recognizing, distinguishing, generating, obtaining, ascertaining, or otherwise determining the escalation request related to the requested computing configuration for the process in the stream computing environment. The escalation request may include a query, inquiry, appeal, demand, command, or other requisition that indicates the required computing configuration for a process in the stream computing environment. The requested computing configuration may include a collection of desired attributes, properties, features, or other aspects that define an operational configuration for a process of the stream computing environment. For instance, the requested computing configuration may designate requested capabilities (e.g., features, functionality, actions), authentications (e.g., access authentication), file system access permissions (e.g., read or write to a protected file system), physical resource utilization permissions (e.g., authorization to use a hardware component, direct network access), encrypted-data access permissions (e.g., encryption keys to encrypt or decrypt data), computing resource allotments (e.g., requests for more processing resources, memory resources, bandwidth), or other features. In embodiments, the escalation request may be detected with respect to a post-compilation phase. The post-compilation phase may include a state of the stream computing application in which a set of source code for the stream computing environment has been converted (e.g., compiled) to an executable application. For instance, in embodiments, the escalation request may be detected for the stream computing application after compilation but in advance of code deployment to the stream computing environment (e.g., with respect to an application packaging phase). In embodiments, detecting may include using a streams authorization engine to receive the escalation request from a container layer of the stream computing environment (e.g., located between the stream computing application and a host operating system). As an example, detecting may include sensing an escalation request from the container layer that indicates a requested computing configuration to allow a process to have direct access to a network to observe incoming and outgoing network traffic. Other methods of detecting an escalation request that relates to a requested computing configuration are also possible.

At block 940, an appropriate computing configuration may be determined for the process in the stream computing environment. The determining may be performed based on the requested computing configuration for the process in the stream computing environment. Generally, determining can include computing, formulating, generating, calculating, selecting, identifying, or otherwise ascertaining the appropriate computing configuration for the process in the stream computing environment. The appropriate computing configuration may include a collection of settings, regulations, stipulations, or parameters that define an operating configuration for the process that is ascertained to be suitable with respect to the security, performance, or other factors of the stream computing environment. In embodiments, the appropriate computing configuration may grant, deny, or modify one or more elements related to the requested capabilities, authentications, file system access permissions, physical resource utilization permissions, encrypted-data access permissions, or computing resource allotments of the requested computing configuration to tailor (e.g., adapt) the computing configuration of the process to the streams computing environment. In embodiments, determining the appropriate computing configuration may include evaluating the requested computing configuration with respect to a set of computing configuration suitability criteria for the stream computing environment. The set of computing configuration suitability criteria may include a set of requirements, benchmarks, or guidelines that govern the degree or extent to which processes may be allowed to perform certain behaviors or access particular aspects of the stream computing environment. As examples, the set of computing configuration suitability criteria may define a threshold amount of computing resources that may be used by a single process (e.g., 3 gigabytes of memory), a security protocol that defines encryption levels (e.g., approved encryption algorithms), a data access authority that indicates how the process may interact with particular types of data (e.g., read access is allowed with respect to a first memory address) or the like. Accordingly, the requested computing configuration may be evaluated with respect to the set of computing configuration suitability criteria to formulate an appropriate computing configuration for the process in the stream computing environment. As an example, with respect to the previous example in which an escalation request was detected that indicated a requested computing configuration to allow a process to have direct access to a network to observe incoming and outgoing network traffic, the requested computing configuration may be evaluated with respect to the set of computing configuration suitability criteria and an appropriate computing configuration may be determined that allows the process to observe the amount of incoming and outgoing network traffic but does not allow the process to directly view the contents of network packets (e.g., based on a data privacy criterion). Other methods of determining the appropriate computing configuration based on the requested computing configuration are also possible.

At block 980, the appropriate computing configuration may be established for the process in the stream computing environment. The establishing may be performed using a containerization technique. Generally, establishing can include instantiating, creating, implementing, setting-up, organizing, arranging, constructing, applying, or otherwise structuring the appropriate computing configuration for the process in the stream computing environment using the containerization technique. The containerization technique may include an operating-system level virtualization method for deploying and running distributed applications without launching a virtual machine for each application. The containerization technique may be used to isolate a stream computing application and associated processes from other stream computing applications running on the same host. In embodiments, establishing the appropriate computing configuration using the containerization technique may include applying the appropriate computing configuration to the stream computing application at container startup. For instance, in response to determining the appropriate computing configuration, the streams authorization engine may transmit a configuration token that indicates the appropriate computing configuration to the container for implementation (e.g., at container start-up time). The container may parse the configuration token and instruct one or more shims (e.g., lightweight libraries for operation handling) to implement the appropriate computing configuration with respect to the process of the stream computing application. As an example, the container may instruct a resource management shim to set a resource usage threshold, an access authorization shim to define access permissions with respect to a file system, and a data traffic management shim to govern input and output traffic with respect to the process in accordance with the appropriate computing configuration. Other methods of establishing the appropriate computing configuration for the process in the stream computing environment using the containerization technique are also possible.

In embodiments, a stream computing application may be partitioned at block 981. The partitioning may be performed using the containerization technique. Generally, partitioning can include arranging, dividing, separating, apportioning, or otherwise organizing the stream computing application to have the set of computing objects. The stream computing application may have a set of computing objects. The set of computing objects may include a collection of code components (e.g., implementation code) configured to implement aspects of the stream computing application. The set of computing objects may include pre-compilation source code or post-compilation machine code. The stream computing application may be partitioned to have both a first subset of the set of computing objects related to a privileged-segment and a second subset of the set of computing objects related to a user-segment. The first subset of computing objects related to the privileged-segment may include a portion, section, or group of computing objects that are associated with restricted access requirements (e.g., particular authentication or access privileges are required for access to be granted). For instance, the privileged segment may include one or more root areas with limited access for non-administrator (e.g., non-developer) users. The second subset of computing objects related to the user-segment may include a portion, section, or group of computing objects that are associated with an open access policy (e.g., non-administrator users may be allowed to access the second subset of computing objects without special access privileges). In embodiments, partitioning may include using a runtime request interface to format the stream computing application to create separate segments for the first and second subsets of computing objects, and subsequently assigning access requirements for each respective subset. In embodiments, the appropriate computing configuration may be established for the process in the stream computing environment. The establishing may pertain to a run-time phase of the stream computing application in the stream computing environment. Generally, establishing can include instantiating, creating, implementing, setting-up, organizing, arranging, constructing, applying, or otherwise structuring the appropriate computing configuration for the process in the stream computing environment using the containerization technique. In embodiments, establishing may include configuring the containerization technique to apply the appropriate computing configuration to the stream computing application with respect to a run-time phase after application packaging and before code deployment. As such, computing configurations for stream computing applications may be modified with respect to runtime (e.g., post-compilation phase) to facilitate stream computing flexibility. Other methods of partitioning the stream computing application to have the set of computing objects and establishing the appropriate computing configuration for the process in the stream computing environment are also possible.

Consider the following example. A stream computing environment may be configured to host a first stream computing application related to managing financial transactions for a set of client accounts. Prior to code deployment, an escalation request that indicates a requested computing configuration for a process of the stream computing environment may be detected. For instance, the escalation request may indicate a requested computing configuration to allow a processing element to perform read and write operations for a set of encryption keys (e.g., to encrypt user financial transaction data) to a memory resource. Accordingly, a streams authorization engine may evaluate the requested computing configuration with respect to a set of computing configuration suitability criteria to determine an appropriate computing configuration for the first stream computing application. In embodiments, a memory access protection criterion of the set of computing configuration suitability criteria may indicate that a first portion of the memory resource is configured for use by a second stream computing application and that the first stream computing application should not be allowed to read or write to the first portion of the memory resource (e.g., to maintain data integrity for the second stream computing application), but that a second portion of the memory resource is not in use and may be used for reading and writing encryption keys by the first stream computing application. Accordingly, the streams authorization engine may determine an appropriate computing configuration that allows the processing element to perform read and write operations of the set of encryption keys to the second portion of the memory resource. The streams authorization engine may transmit a configuration token to a container that manages the first stream computing application, and the container may use one or more shims to configure access permissions for the memory resource to establish the appropriate computing configuration for the first stream computing application. Subsequent to establishment of the appropriate computing configuration, a set of computing objects (e.g., implementation code) may be deployed to the stream computing environment for execution. Other methods of post-compilation configuration management in a stream computing environment are also possible.

Method 900 concludes at block 999. Aspects of method 900 may provide performance or efficiency benefits related to post-compilation configuration management in a stream computing environment to process a stream of tuples. As an example, computing configurations may be managed externally to the stream computing application (e.g., using a containerization engine) to facilitate granular control of the capabilities and access permissions of the stream computing application. Altogether, leveraging post-compilation configuration management with respect to a stream computing application may be associated with benefits such as data security, stream computing configuration flexibility, and stream computing application performance. Aspects may save resources such as bandwidth, processing, or memory.

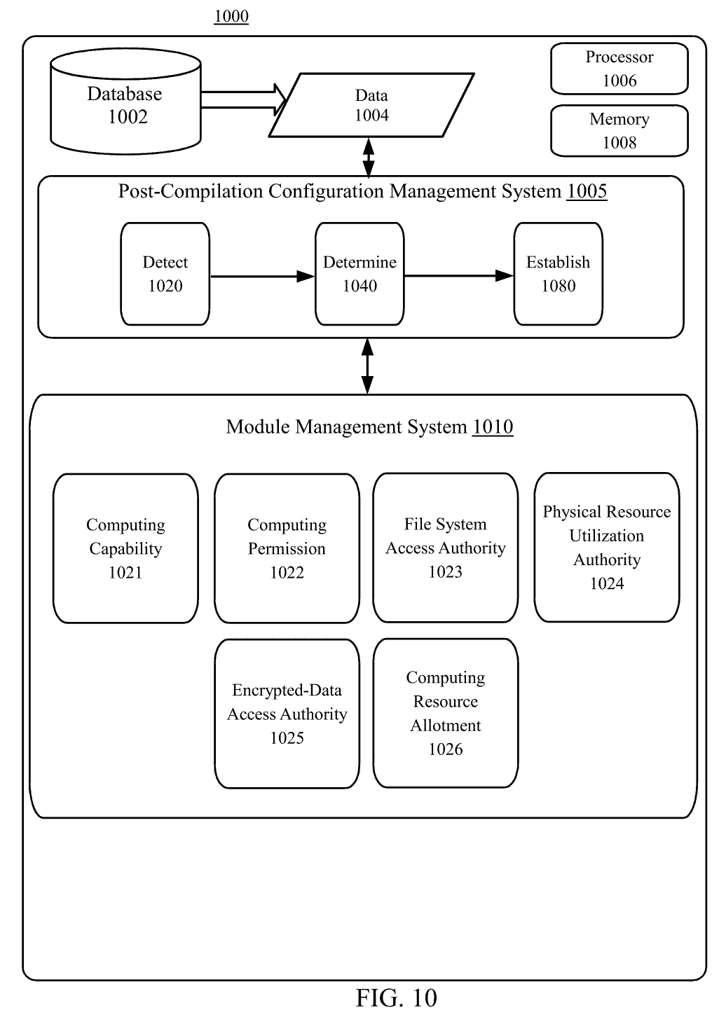

FIG. 10 shows an example system 1000 for post-compilation configuration management in a stream computing environment to process a stream of tuples, according to embodiments. The example system 1000 may include a processor 1006 and a memory 1008 to facilitate implementation of post-compilation configuration management. The example system 1000 may include a database 1002 configured to maintain data used for post-compilation configuration management. In embodiments, the example system 1000 may include a post-compilation configuration management system 1005. The post-compilation configuration management system 1005 may be communicatively connected to the database 1002, and be configured to receive data (e.g., tuples, data blocks) 1004 related to post-compilation configuration management. The post-compilation configuration management system 1005 may include a detecting module 1020 to detect an escalation request, a determining module 1040 to determine an appropriate computing configuration, and an establishing module 1080 to establish the appropriate computing configuration. The post-compilation configuration management system 1005 may be communicatively connected with a module management system 1010 that includes one or more modules or sub-modules for implementing aspects of post-compilation configuration management.

In embodiments, the escalation request may be detected at module 1021. The escalation request may relate to a requested computing capability for the process in the stream computing environment. The detecting may pertain to the post-compilation phase in the stream computing environment. Generally, detecting can include sensing, discovering, collecting, recognizing, distinguishing, generating, obtaining, ascertaining, or otherwise determining the escalation request related to the requested computing capability for the process in the stream computing environment. The requested computing capability may include a desired function, behavior, feature, or ability to perform an action by the process in the stream computing environment. For instance, the requested computing capability may include a requisition for authorization to perform an operation using the process. As examples, the requested computing capability may include functions such as locking a portion of memory, overriding mandatory access control, allowing read operations (e.g., with respect to an audit log), allowing write operations (e.g., to a kernel auditing long), binding sockets to internet domain privileged ports, modifying routing tables, installing device drivers, or the like. In embodiments, detecting may include using the streams authorization engine to parse the escalation request and identify one or more capability identifiers that indicate specific computing capabilities requested by the process in the stream computing environment. For instance, the escalation request may be parsed, and a capability identifier of “CAP_IPC_LOCK” may be determined that indicates a requested capability of locking a memory portion. Other methods of detecting the requested computing capability for the process in the stream computing environment are also possible.

In embodiments, an appropriate computing capability may be determined for the process in the stream computing environment. The determining may be performed based on the requested computing capability for the process in the stream computing environment. Generally, determining can include computing, formulating, generating, calculating, selecting, identifying, or otherwise ascertaining the appropriate computing capability for the process. The appropriate computing capability may include one or more computing functions or features that are ascertained to be suitable with respect to the security, performance, or other factors of the stream computing environment. In embodiments, the appropriate computing capability may include a modified version of a requested computing capability to limit or extend the authorization of the process. For instance, with reference to a requested computing capability to lock a memory portion, the appropriate computing capability may include an authorization for the process to lock a subset of the memory portion, or lock the memory portion for a determined period of time. In embodiments, determining the appropriate computing capability may include filtering the requested computing configuration to a set of computing capabilities that achieve a satisfaction threshold (e.g., the fewest/strictest capabilities that can be provided while still satisfying the requested computing capability). As such, system vulnerabilities associated with capability exploitation (e.g., user processes that misuse capabilities) may be avoided. In embodiments, the appropriate computing capability may be established for the process in the stream computing environment. The establishing may be performed using the containerization technique. Generally, establishing can include instantiating, creating, implementing, setting-up, organizing, arranging, constructing, applying, or otherwise structuring the appropriate computing capability for the process in the stream computing environment. In embodiments, establishing may include utilizing the container to configure a set of access permissions to provide the appropriate computing capability to the process in the stream computing environment. Other methods of determining the appropriate computing capability and establishing the appropriate computing capability for the process in the stream computing environment are also possible.

In embodiments, an escalation request related to a requested computing permission may be detected at module 1022. An appropriate computing permission may be determined for the process in the stream computing environment. The appropriate computing permission may be established for the process in the stream computing environment. In embodiments, the detecting, determining, and establishing of the appropriate computing permission may be performed consistent with embodiments described herein. The requested computing permission may include a desired authorization, privilege, approval, license, or authentication to be granted to the process in the stream computing environment. For instance, the requested computing permission may include a requisition to access data stored in a database. As examples, the requested computing permission may include a request for authorization to bypass file read permission checks, load and unload kernel modules, access input/output port operations, enable multicasting, enable and disable kernel auditing, and the like. In embodiments, an appropriate computing permission may be determined and established for the process in the stream computing environment. The appropriate computing permission may include an authorization with respect to one or more computing functions or features that are ascertained to be suitable with respect to the security, performance, or other factors of the stream computing environment. As an example, with respect to a requested computing permission to access a table of encryption keys, an appropriate computing permission may select a subset of encryption keys that are associated with a timestamp beyond a date threshold that may be accessed by the process. Other methods of determining and establishing an appropriate computing permission for a process based on an escalation request related to a requested computing permission are also possible.

In embodiments, an escalation request related to a file system access authority may be detected at module 1023. An appropriate file system access authority may be determined for the process in the stream computing environment. The appropriate file system access authority may be established for the process in the stream computing environment. In embodiments, the detecting, determining, and establishing of the appropriate file system access authority may be performed consistent with embodiments described herein. The requested file system access authority may include a desired authorization, privilege, approval, license, or authentication to be granted to the process with respect to a file system in the stream computing environment. For instance, the requested file system access authority may include a requisition for an authorization to add data to a file system, delete data from a file system, edit existing data in the file system, or the like. As examples, the requested file system access authority may include a request for authorization to set access control lists (ACLs) on arbitrary files, set group ID bits for files, establish leases on files, set file capabilities, set extended file attributes on files, or perform various other privileged file system operations. In embodiments, an appropriate file system access authority may be determined and established for the process in the stream computing environment. The appropriate file system access authority may include an authorization with respect to one or more file system operations that are ascertained to be suitable with respect to the security, performance, or other factors of the stream computing environment. As an example, with respect to a requested file system access authority to perform read and write operations with respect to a set of files in a file system, an appropriate file system access authority may be determined that allows the process to perform read operations with respect to the set of files in the file system, but only perform write operations with respect to files that were created by a first user (e.g., files created by other users may be associated with stricter privacy policies). Other methods of determining and establishing an appropriate file system access authority for a process based on an escalation request related to a requested file system access authority are also possible.

In embodiments, an escalation request related to a requested physical resource utilization authority may be detected at module 1024. An appropriate physical resource utilization authority may be determined for the process in the stream computing environment. The appropriate physical resource utilization authority may be established for the process in the stream computing environment. In embodiments, the detecting, determining, and establishing of the appropriate physical resource utilization authority may be performed consistent with embodiments described herein. The requested physical resource utilization authority may include a desired authorization, privilege, approval, license, or authentication to be granted to the process with respect to a usage of a physical hardware resource. The physical resource may include a hardware device communicatively connected with the stream computing environment. For instance, the physical resource may include a component of the host computing node to which the stream computing application is scheduled for deployment (e.g., network attached storage device, input/output devices, memory, processors, registers). As examples, the requested physical resource utilization authority may include a requisition to be allowed access to view system information, configure hardware settings, manage system tasks/resources, or be granted other administrative privileges with respect to one or more physical resources. In embodiments, an appropriate physical resource utilization authority may be determined and established for the process in the stream computing environment. The appropriate physical resource utilization authority may include an authorization (e.g., or prevention) for the process to utilize one or more hardware resources in the stream computing environment that are ascertained to be suitable with respect to the security, performance, or other factors of the stream computing environment. As an example, with respect to a requested physical resource utilization authority to directly connect to a network adapter to view incoming and outgoing network traffic for all applications on a host hardware device, an appropriate physical resource utilization authority may be determined to allow the process to directly connect to the network adapter and view incoming and outgoing data traffic from a first network cable but not a second network cable (e.g., data transferred on the second network cable may be associated with a stricter security policy). Other methods of determining and establishing an appropriate physical resource utilization authority for a process based on an escalation request related to a requested physical resource utilization authority are also possible.

In embodiments, an escalation request related to a requested encrypted-data access authority may be detected at module 1025. An appropriate encrypted-data access authority may be determined for the process in the stream computing environment. The appropriate encrypted-data access authority may be established for the process in the stream computing environment. In embodiments, the detecting, determining, and establishing of the appropriate encrypted-data access authority may be performed consistent with embodiments described herein. The set of encrypted data may include a collection of information that is encoded in ciphertext to prevent access by unauthorized parties. In embodiments, the set of encrypted data may include plain text data that is stored within an encrypted file system, data store, or protected memory component. In embodiments, the requested encrypted-data access authority may include a desired authorization, privilege, approval, license, or authentication to be granted to the process with respect to a set of encrypted data. As examples, the requested encrypted-data access authority may include a requisition to be allowed permission to access encrypted data, manage encryption keys, transmit encryption keys, decrypt encrypted data, select encryption algorithms for data sets, or the like. In embodiments, an appropriate encrypted-data access authority may be determined and established for the process in the stream computing environment. The appropriate encrypted-data access authority may include an authorization (e.g., or prevention) to grant (e.g., or deny) one or more administrative privileges to the process with respect to the set of encrypted data that are ascertained to be suitable with respect to the security, performance, or other factors of the stream computing environment. As an example, with respect to a requested encrypted-data access authority to manage encryption keys for a set of encrypted data, an appropriate encrypted-data access authority may be determined to allow the process to decrypt existing encrypted data, but prevent the process from defining new encryption keys for the set of encrypted data. Other methods of determining and establishing an appropriate encrypted-data access authority for a process based on an escalation request related to a requested encrypted-data access authority are also possible.

In embodiments, an escalation request related to a requested computing resource allotment may be detected at module 1026. An appropriate computing resource allotment may be determined for the process in the stream computing environment. The appropriate computing resource allotment may be established for the process in the stream computing environment. In embodiments, the detecting, determining, and establishing of the appropriate computing resource allotment may be performed consistent with embodiments described herein. The requested computing resource allotment may include a desired authorization, privilege, or approval to utilize a designated amount of computing resources by the process in the stream computing environment. As examples, the requested computing resource allotment may include a requisition with respect to a set of processing resources (e.g., 3 gigahertz), a set of memory resources (e.g., 4 gigabytes of memory), a set of bandwidth resources (e.g., 1 gigabit per second), a set of input/output resources (e.g., 1000 input/output operations per second), a set of storage resources (e.g., 100 gigabytes of storage space), or the like. In embodiments, an appropriate computing resource allotment may be determined and established for the process in the stream computing environment. The appropriate computing resource allotment may include an authorization (e.g., or prevention) to grant (e.g., or deny) permission to the process to utilize a particular amount of computing resources that are ascertained to be suitable with respect to the security, performance, or other factors of the stream computing environment. As an example, with respect to a requested computing resource allotment of 4 gigahertz of processing resources and 12 gigabytes of memory, an appropriate computing resource allotment may be determined to provide the process with 3.5 gigahertz of processing resources and 10 gigabytes of memory. Other methods of determining and establishing an appropriate computing resource allotment for a process based on an escalation request related to a requested computing resource allotment are also possible.

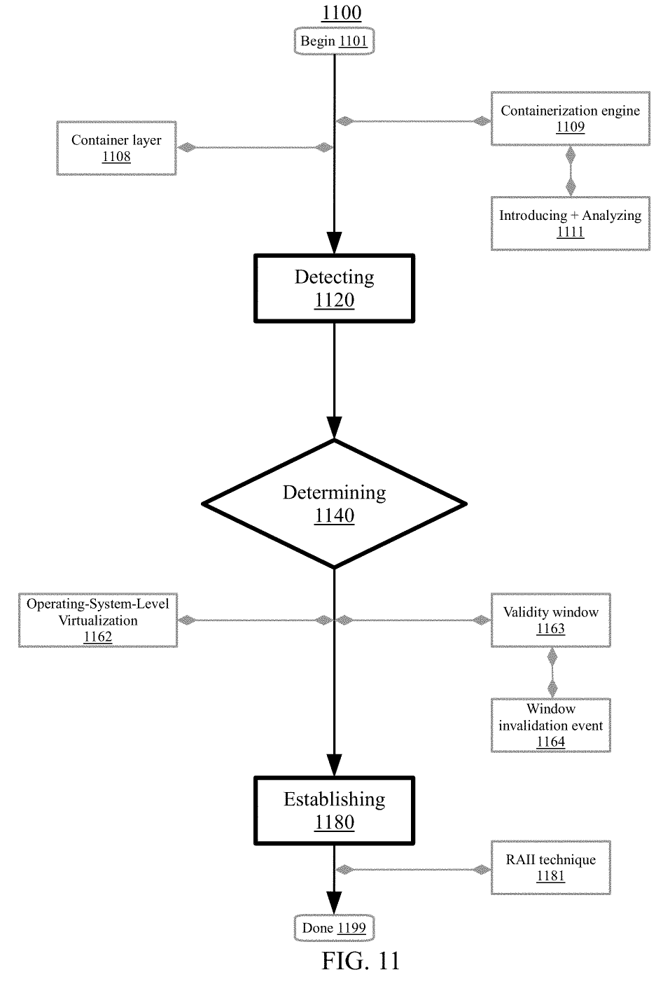

FIG. 11 is a flowchart illustrating a method 1100 for post-compilation configuration management in a stream computing environment to process a stream of tuples, according to embodiments. Aspects of 1100 may be similar or the same as aspects of method 900/1000, and aspects may be utilized interchangeably. Aspects of the method 1100 relate to managing a computing configuration for a stream computing application. Leveraging post-compilation configuration management with respect to a stream computing application may be associated with benefits such as data security, stream computing configuration flexibility, and stream computing application performance. The method 1100 may begin at block 1101.

In embodiments, a container layer may be introduced between a set of user processes and an operating system at block 1108. The introducing may be performed in the stream computing environment. Generally, introducing can include instantiating, initiating, utilizing, establishing, installing, adding, inserting, or otherwise implementing the container layer between the set of user processes and an operating system. The set of user processes may include one or more instances of the stream computing application that are configured to perform tasks or implement functionality within the stream computing environment. As examples, the set of user processes may include memory read operations to fetch data from main memory, write operations to store data to a database, compression operations to compress data for transmission, encryption operations to generate a hash to protect a set of data, or the like. The operating system may include a host operating system configured to support one or more virtualized environments (e.g., virtual machines, containers) to facilitate maintenance and operation of the stream computing application. In embodiments, aspects of the disclosure relate to the recognition that direct communication between user processes and a host operating system may be associated with system vulnerabilities, as user processes may independently create their own computing configurations and assign themselves administrator-level privileges. Accordingly, aspects of the disclosure relate to introducing a container layer between the set of user processes and the operating system to isolate the set of user processes and facilitate granular control of computing configuration determination (e.g., by a streams authorization engine and the container). The container layer may include an instantiation of a writeable image layer on top of a readable image layer such that changes made by the set of user processes are stored separately from the operating system. In embodiments, the container layer may be configured to transmit escalation requests from the set of user processes to the operating system. In embodiments, introducing the container layer may include using a container virtualization program to attach a new logical layer to a container, and position the new logical layer between an operating system kernel and the stream computing application. Other methods of introducing the container layer between the set of user processes and the operating system are also possible.

In embodiments, a containerization engine may be introduced at block 1109. The containerization engine may be introduced to interface with an authentication management engine. The introducing may be performed to manage one or more computing configurations of a stream computing application. The introducing may be performed in the stream computing environment. Generally, introducing can include instantiating, initiating, utilizing, establishing, installing, adding, inserting, or otherwise implementing the containerization engine to interface with the authentication management engine. The containerization engine may include a software module or platform configured to implement and manage virtual containers with respect to the stream computing application. The containerization engine may be used to run multiple isolated virtual containers on a control host using a single host operating system kernel. In embodiments, the containerization engine may be introduced to interface with an authentication management engine. The authentication management engine (e.g., also referred to herein as a streams authorization engine) may include a software management application or service configured to validate the authorization of process behaviors within the stream computing environment. For instance, the authentication management engine may define permissions, assign privileges, and determine computing configurations for processes of stream computing applications deployed to the stream computing environment. In embodiments, introducing the containerization engine may include linking, coupling, attaching, joining, or otherwise communicatively connecting the authentication management engine with the containerization engine to facilitate computing configuration implementation with respect to a stream computing application. As an example, the authentication management engine may be configured to determine a computing configuration for a stream computing application, pass a configuration token that indicates the computing configuration to the containerization engine, and instruct the containerization engine to apply the computing configuration with respect to the stream computing application. As such, the computing configuration for a stream computing application may be dynamically modified and implemented using the containerization engine prior to code deployment. Other methods of introducing the containerization engine to interface with the authentication management engine are also possible.

In embodiments, a shim may be introduced at block 1111. The shim may be introduced to manage the escalation request. The introducing may be performed in the stream computing environment. Generally, introducing can include instantiating, initiating, utilizing, establishing, installing, adding, inserting, or otherwise implementing the shim to manage the escalation request. The shim may include a lightweight library configured to receive process requests (e.g., application programming interface calls) and perform operations to manage request resolution. For instance, the shim may perform an operation to resolve a request directly, or redirect the request to a dedicated hardware component or software module for handling. In embodiments, introducing may include configuring a set of shims to each implement an aspect or element of the computing configuration with respect to the stream computing application. As an example, a resource management shim may be utilized to set a resource usage threshold, an access authorization shim may be utilized to define access permissions with respect to a file system, and a data traffic management shim may be utilized to govern input and output traffic with respect to the process in accordance with the appropriate computing configuration determined based on the escalation request. The escalation request may be analyzed. The analyzing may be performed in the stream computing environment in an external fashion with respect to the process. Generally, analyzing can include investigating, parsing, interpreting, evaluating, or otherwise examining the escalation request. In embodiments, analyzing may include using the authentication management engine to parse the escalation request to identify a configuration element identifier to indicate specific computing capabilities, permissions, resource requests, or other aspects requested by the process of the stream computing application, and subsequently transmitting the configuration element identifier to one or more shims for implementation with respect to the stream computing application. As such, the escalation request may be analyzed independently with respect to the stream computing application to facilitate data security (e.g., prevent stack smashing, overflow exploits). Other methods of introducing the shim to manage the escalation request and analyzing the escalation request in an external fashion are also possible.

At block 1120, an escalation request may be detected. The escalation request may pertain to a post-compilation phase in the stream computing environment. The escalation request may relate to a requested computing configuration for a process in the stream computing environment. At block 1140, an appropriate computing configuration may be determined for the process in the stream computing environment. The determining may be performed based on the requested computing configuration for the process in the stream computing environment.

In embodiments, the containerization technique may be structured at block 1162. The containerization technique may be structured to include an operating-system-level virtualization for running multiple isolated systems on a control host using a single kernel. Generally, structuring can include building, formatting, arranging, constructing, organizing, assembling, or otherwise configuring the containerization technique to include the operating-system-level virtualization for running multiple isolated systems on the control host using a single kernel. In embodiments, structuring the containerization technique may include establishing an independent, separate container for each stream computing application of a control host. Each stream computing application may be isolated within its own container, and be unaware of other containers and stream computing applications sharing the same control host. As an example, structuring the containerization technique may include utilizing a Linux Container (LXC; registered trademark of Linus Torvalds) to assign an independent namespace for each stream computing application to isolate and virtualize system resources of each stream computing application of the control host. For instance, the namespaces may be used to virtualize and isolate process identifiers, hostnames, user identifiers, network access, interprocess communication, and file systems. In embodiments, the appropriate computing configuration may be established for the process in the stream computing environment. The establishing may be performed using the operating-system-level virtualization for running multiple isolated systems on the control host using the single kernel. Generally, establishing can include instantiating, creating, implementing, setting-up, organizing, arranging, constructing, applying, or otherwise structuring the appropriate computing configuration using the operating-system-level virtualization. In embodiments, establishing the appropriate computing configuration may include using one or more shims to configure access privileges, allocate resources, define security levels, govern authorization settings, and configure other aspects of the particular container that includes the stream computing application. As described herein, the appropriate computing configuration may be implemented with respect to an individual container to manage a particular stream computing application, such that multiple stream computing applications of the control host may be associated with independent computing configurations. Other methods of structuring the containerization technique to include the operating-system-level virtualization and establishing the appropriate computing configuration using the operating-system-level virtualization are also possible.

In embodiments, the appropriate computing configuration may be structured to have a validity window at block 1163. The structuring may be performed for the process in the stream computing environment. Generally, structuring can include building, formatting, arranging, constructing, organizing, assembling, or otherwise configuring the appropriate computing configuration to have the validity window. The validity window may include a limitation, restraint, condition, or other parameter that governs usage of the appropriate computing configuration by the stream computing application. For instance, in embodiments, the validity window may include a temporal threshold that defines a period of time (e.g., 4 hours) with respect to which the appropriate computing configuration may be used, or an expiration time (e.g., November 5th at 4:00 PM) at which the appropriate computing configuration may be revoked or re-evaluated. In certain embodiments, the validity window may be defined based on a triggering event, such that detection of the triggering event enables or disables use of the appropriate computing configuration. As examples, the triggering event may include behavior of the stream computing application (e.g., amount of resources being used, which memory addresses are being accessed by processes), modifications made with respect to stream computing application components (e.g., stream operators, processing elements, hostpools), stream application performance characteristics (e.g., throughput above or below a threshold, ingestion of a threshold number of tuples) or the like. In embodiments, the appropriate computing configuration may be established for the process in the stream computing environment. The establishing may be performed for utilization within the validity window. Generally, establishing can include instantiating, creating, implementing, setting-up, organizing, arranging, constructing, or otherwise applying the appropriate computing configuration for utilization within the validity window. In embodiments, establishing may include defining a validity window with respect to the appropriate computing configuration using the containerization process. For instance, in response to determining the appropriate computing configuration, the authentication management engine may ascertain a validity window and transmit an indication of the validity window together with the appropriate computing configuration to the container for implementation. As an example, establishing may include using the container to define a validity window of “Until memory utilization exceeds 3 gigabytes” with respect to a particular appropriate computing configuration (e.g., usage of the appropriate computing configuration may be authorized until application resource usage exceeds a memory threshold). Other methods of structuring the appropriate computing configuration to have the validity window and establishing the appropriate computing configuration for utilization within the validity window are also possible.

In embodiments, a window invalidation event may be sensed at block 1164. The window invalidation event may indicate a conclusion of the validity window. Generally, sensing can include detecting, discovering, collecting, recognizing, distinguishing, generating, obtaining, ascertaining, or otherwise determining the window invalidation event that indicates the conclusion of the validity window. The window invalidation event may include an action, occurrence, or trigger that brings about closing or termination of the validity window. As examples, the window invalidation event may include elapsing of a defined time period (e.g., 2 hours), deployment of a set of processing elements (e.g., deploying the stream computing application to the host), execution of a set of processing operations, reception of a set of data, performance of a particular action by the stream computing application, resource usage above a threshold, or the like. As an example, consider a user process of a stream computing application that is associated with an appropriate computing configuration that allows access to a protected memory location that has a defined validity window that revokes access in the event that write operations are performed with respect to a first subset of memory locations of the protected memory location (e.g., to prevent a user process from editing data for which they do not have ownership rights). Accordingly, sensing the window invalidation event may include detecting that the user process scheduled a write operation with respect to a memory location of the first set of memory locations, and subsequently terminating the validity window to revoke access to the appropriate computing configuration by the user process.

In embodiments, a distinct computing configuration may be established for the process in the stream computing environment. The establishing may be performed for utilization outside-of the validity window. Generally, establishing can include instantiating, creating, implementing, setting-up, organizing, arranging, constructing, applying, or otherwise structuring the distinct computing configuration. The distinct computing configuration may include a collection of settings, regulations, stipulations, or parameters that define an operating configuration for the process in the stream computing environment. The distinct computing configuration may differ with respect to the requested computing configuration, the appropriate computing configuration, or both (e.g., at least one or more parameters or settings may differ between the distinct computing configuration and the requested computing configuration/appropriate computing configuration). In embodiments, establishing the distinct computing configuration may include returning (e.g., reverting, rolling-back) the computing configuration of the process to a prior state (e.g., before implementation of the appropriate computing configuration). In certain embodiments, establishing the distinct computing configuration may include freezing (e.g., halting, stopping, pausing) a current computing configuration to disallow new configuration changes but maintain those changes made up to the point in time when the computing configuration was frozen. In certain embodiments, establishing the distinct computing configuration may include formulating a computing configuration with limited privileges to facilitate security with respect to the stream computing environment. For instance, consider once more the example described herein in which a window invalidation event is detected with respect to a user process that attempted to perform a write operation to a protected memory location. Establishing the distinct computing configuration may include modifying a set of access privileges for the user process with respect to the protected memory location to only allow read operations, and forbid write operations to maintain data security (e.g., as the user process may be associated with a lower level of trust). Other methods of sensing the window invalidation event and establishing the distinct computing configuration are also possible.

At block 1180, the appropriate computing configuration may be established for the process in the stream computing environment. The establishing may be performed using a containerization technique.

In embodiments, the appropriate computing configuration may be established in the stream computing environment using a resource acquisition is initialization (RAII) technique at block 1181. The RAII technique may be performed in advance of running a set of processing elements to process the stream of tuples. Generally, establishing can include instantiating, creating, implementing, setting-up, organizing, arranging, constructing, applying, or otherwise structuring the appropriate computing configuration using the RAII technique. The RAII technique may include a method of resource management in which resource (e.g., acquisition) and authorization assignment for the stream computing application is performed prior to code deployment. In this way, the appropriate computing configuration may be defined for the stream computing environment before initialization of the stream computing application to facilitate operational isolation. In embodiments, establishing the appropriate computing configuration using the RAII technique may include configuring the set of containers to apply the access privileges, security requirements, resource allocations, and other parameters that define the appropriate computing configuration at container start-up (e.g., before code is deployed to the set of containers). In embodiments, the set of processing elements may be run in response to establishing the appropriate computing configuration in the stream computing environment. The running may be performed using the appropriate computing configuration in the stream computing environment to process the stream of tuples. Generally, running can include executing, performing, implementing, carrying-out, or otherwise operating the set of processing elements using the appropriate computing configuration in the stream computing environment to process the stream of tuples. In embodiments, running may include initializing the set of processing elements within the container and scheduling one or more jobs, tasks, or operations to process tuples in the stream computing environment in accordance with the RAII technique. In embodiments, running may include maintaining the appropriate computing configuration for the set of processing elements for the lifetime of a process (e.g., and returning to a default computing configuration upon process completion). Other methods of establishing the appropriate computing configuration using the RAII technique and running the set of processing elements using the appropriate computing configuration are also possible.

Method 1100 concludes at block 1199. Aspects of method 1100 may provide performance or efficiency benefits related to post-compilation configuration management. Altogether, leveraging post-compilation configuration management with respect to a stream computing application may be associated with benefits such as data security, stream computing configuration flexibility, and stream computing application performance. Aspects may save resources such as bandwidth, processing, or memory.

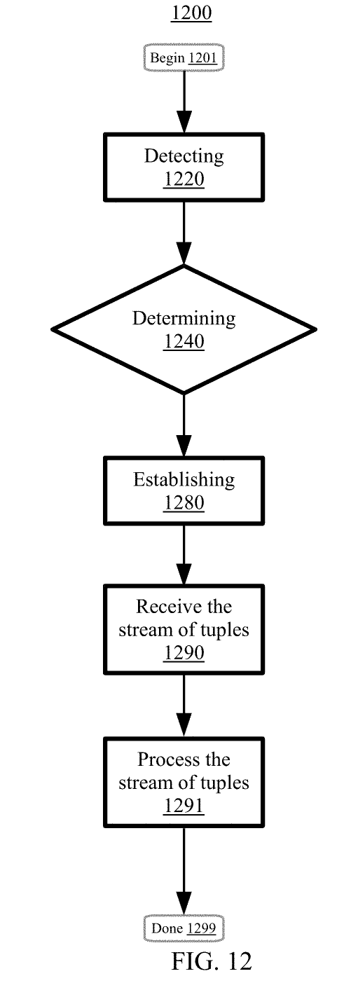

FIG. 12 is a flowchart illustrating a method 1200 for post-compilation configuration management in a stream computing environment to process a stream of tuples, according to embodiments. Aspects of 1200 may be similar or the same as aspects of method 900/1000/1100, and aspects may be utilized interchangeably. The method 1200 may begin at block 1201. At block 1220, an escalation request may be detected. The escalation request may pertain to a post-compilation phase in the stream computing environment. The escalation request may relate to a requested computing configuration for a process in the stream computing environment. At block 1240, an appropriate computing configuration may be determined for the process in the stream computing environment. The determining may be performed based on the requested computing configuration for the process in the stream computing environment. At block 1280, the appropriate computing configuration may be established for the process in the stream computing environment. The establishing may be performed using a containerization technique.

At block 1290, the stream of tuples may be received to be processed by a set of processing elements. The set of processing elements may operate on a set of compute nodes in the stream computing environment having the appropriate computing configuration. The stream of tuples may be received consistent with the description herein including FIGS. 1-16. Current/future processing by the plurality of processing elements may be performed consistent with the description herein including FIGS. 1-16. The set of compute nodes may include a shared pool of configurable computing resources. For example, the set of compute nodes can include a public cloud environment, a private cloud environment, a distributed batch data processing environment, or a hybrid cloud environment. In certain embodiments, each of the set of compute nodes are physically separate from one another.

At block 1291, the stream of tuples may be processed. The processing may be performed using the set of processing elements operating on the set of compute nodes in the stream computing environment having the appropriate computing configuration. The stream of tuples may be processed consistent with the description herein including FIGS. 1-16. In embodiments, stream operators operating on the set of compute nodes may be utilized to process the stream of tuples. Processing of the stream of tuples by the plurality of processing elements may provide various flexibilities for stream operator management. Overall flow (e.g., data flow) may be positively impacted by utilizing the stream operators.

Method 1200 concludes at block 1299. Aspects of method 1200 may provide performance or efficiency benefits related to post-compilation configuration management. Altogether, leveraging post-compilation configuration management with respect to a stream computing application may be associated with benefits such as data security, stream computing configuration flexibility, and stream computing application performance. Aspects may save resources such as bandwidth, processing, or memory.

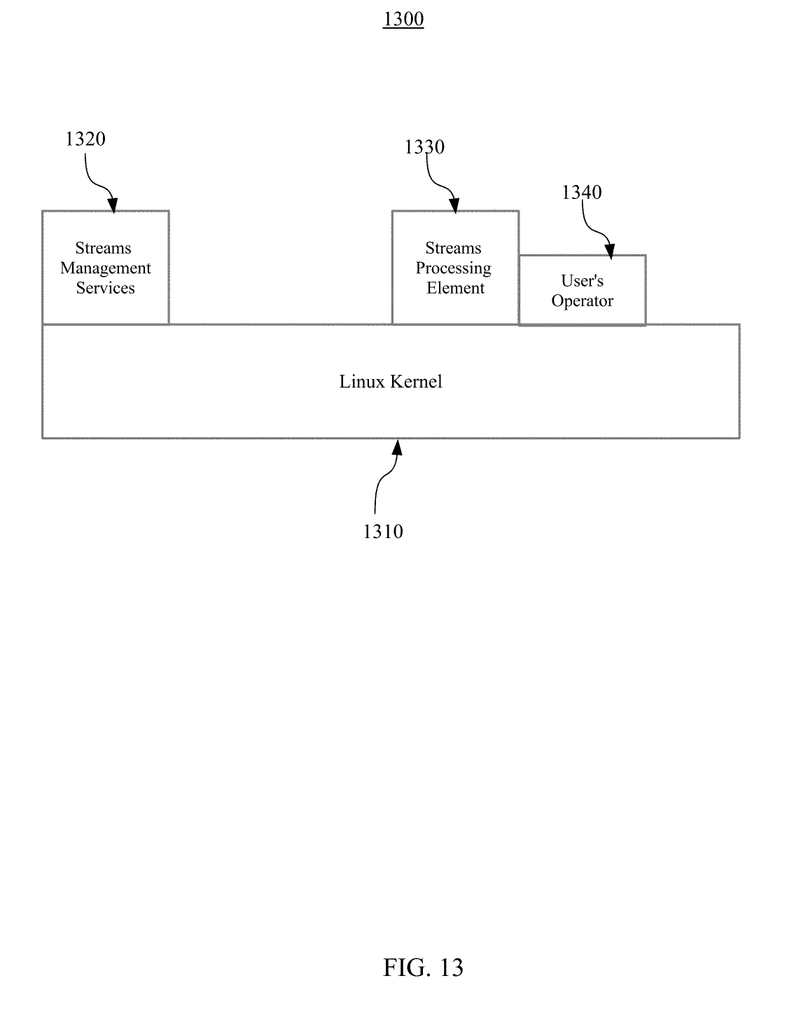

FIG. 13 shows an example system 1300 for post-compilation configuration management in a stream computing environment to process a stream of tuples, according to embodiments. Aspects of the system 1300 illustrate an example infrastructure of a host environment to facilitate operation and execution of a stream computing application. As shown in FIG. 13, the system 1300 may include a Linux (trademark of Linus Torvalds) kernel 1310. The Linux kernel 1310 may include a computer program to manage start-up operations, input/output requests, data-processing instructions, and resource allocation for an operating system. In embodiments, the Linux kernel 1310 may be used to host a streams processing element 1330 as part of a stream computing application. The streams processing element 1330 may include a software module or code component configured to perform a function or operation within the stream computing environment. The streams processing element 1330 may be communicatively connected (e.g., linked) with a user operator 1340. The user operator 1340 may be configured to perform processing operations on input tuples to generate output tuples as part of a user process of the stream computing application. In embodiments, the streams processing element 1330 and the user operator 1340 may be managed by a streams management service 1320. The streams management service (e.g., streams authorization engine, authentication management engine) may be configured to define access permissions, resource usage allocations, capabilities, and other administrator privileges for the processing element 1330 and the user operator 1340. Other types of infrastructures for post-compilation configuration management in a stream computing environment are also possible.

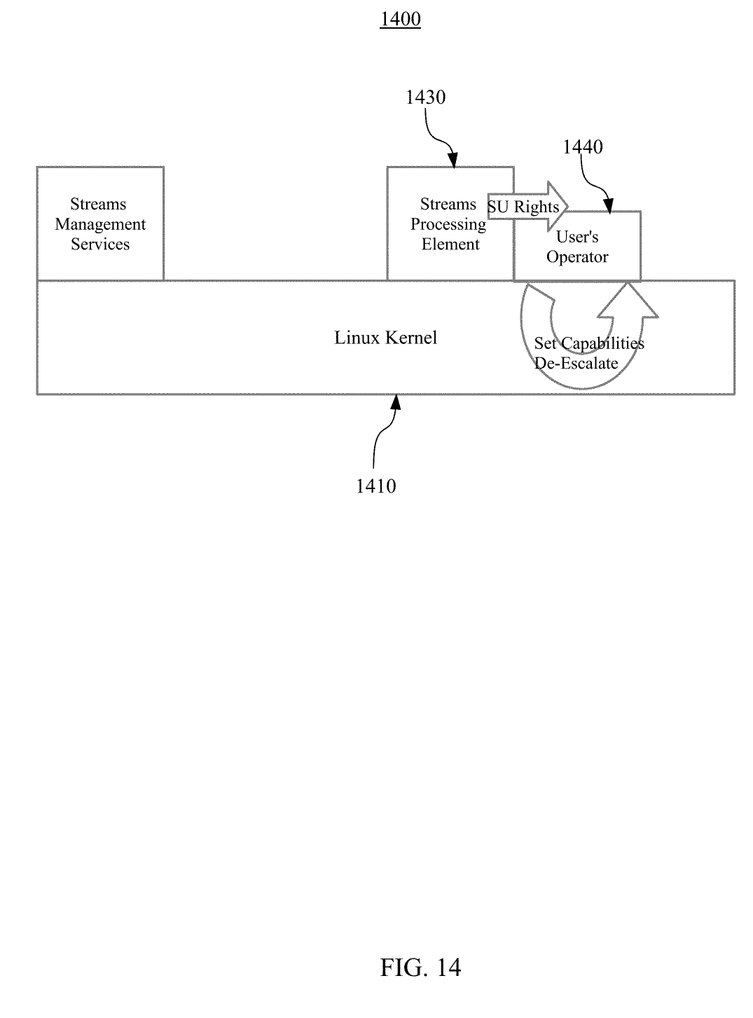

FIG. 14 shows an example system 1400 for post-compilation configuration management in a stream computing environment to process a stream of tuples, according to embodiments. Aspects of FIG. 14 relate to an example infrastructure of a host environment to facilitate establishment of a computing configuration for a stream computing environment. In embodiments, the Linux kernel 1410 may be configured to instruct the streams processing element 1430 to resolve an escalation request from a user operator 1440 to establish a computing configuration for the user operator 1440 (e.g., set capabilities, define access privileges). Aspects of the disclosure relate to the recognition that, in some situations, direct establishment of the computing configuration for the user operator 1440 by the Linux kernel 1410 may be associated with security challenges (e.g., the user operator 1410 may assign itself administrator privileges that may allow for exploitation). Accordingly, aspects of the disclosure relate to utilization of a container layer between the Linux kernel 1410 and a stream computing application to facilitate operational security.

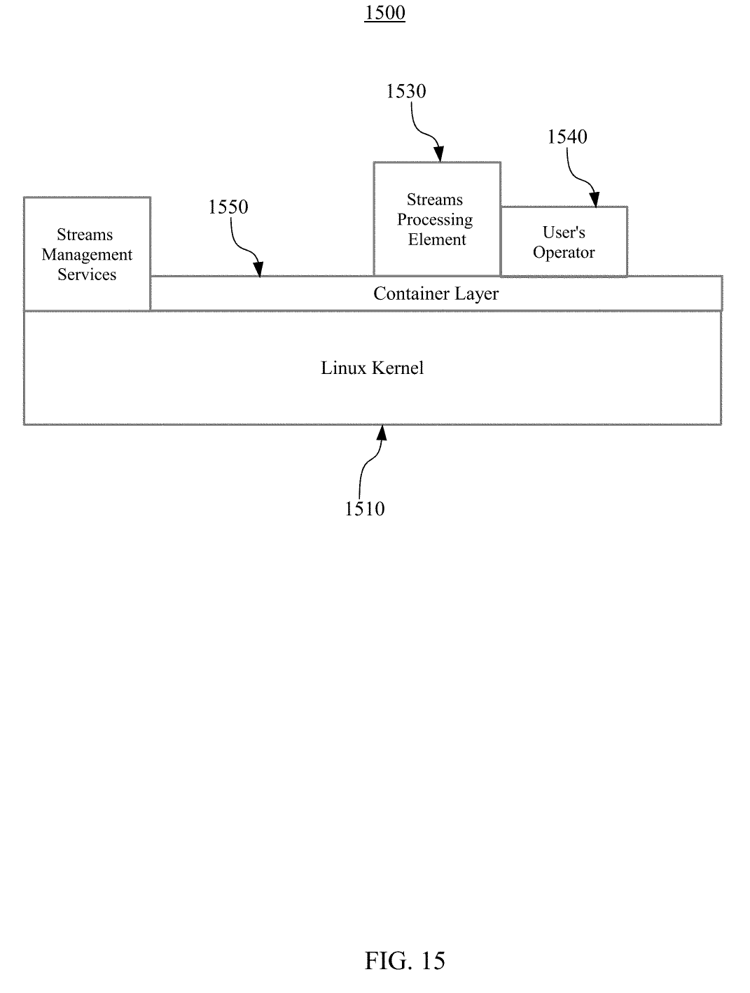

FIG. 15 shows an example system 1500 for post-compilation configuration management in a stream computing environment to process a stream of tuples, according to embodiments. Aspects of system 1500 relate to introducing a container layer 1550 between the Linux kernel 1510 and the stream processing element 1530 and user operator 1540. The container layer 1550 may include an instantiation of a writeable image layer on top of a readable image layer such that changes made by a user operator 1540 are stored separately from the Linux kernel 1510. In embodiments, the container layer 1550 may be configured to transmit escalation requests from the streams processing element 1530 to the Linux kernel 1510. The container layer 1550 may be used to instantiate an appropriate computing configuration with respect to the streams processing element 1530 and the user operator 1540. As such, the container layer 1550 may be used to isolate the user operator 1540 from the Linux kernel 1510 to promote data security in the stream computing environment. Other types of infrastructures for post-compilation configuration management in a stream computing environment are also possible.

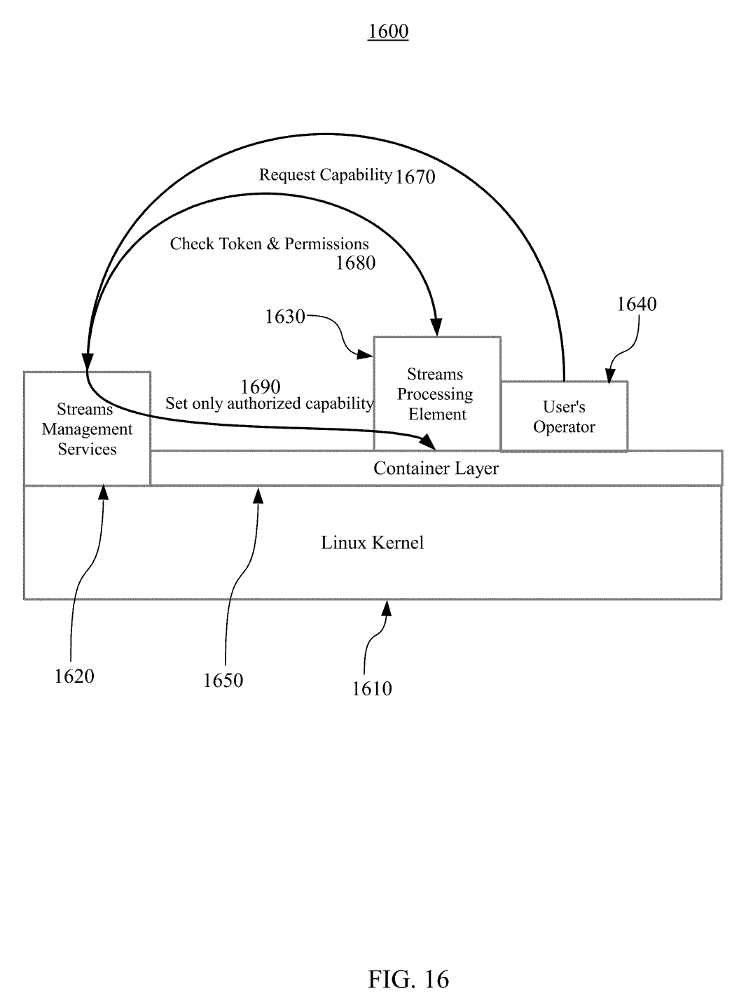

FIG. 16 shows an example system 1600 for post-compilation configuration management in a stream computing environment to process a stream of tuples, according to embodiments. Aspects of FIG. 16 relate to establishing an appropriate computing configuration for a stream computing application using a container layer 1650. In embodiments, the user operator 1640 may submit an escalation request 1670 (e.g., request capability) that indicates a requested computing configuration to a streams management service 1620. The streams management service 1620 may perform a token and permission check 1680 to evaluate the operating configuration of the streams processing element 1630 (e.g., with respect to a set of computing configuration suitability criteria), and determine an appropriate computing configuration for the user operator 1640. The streams management service 1620 may pass a token indicating the appropriate computing configuration to the container layer 1650 running on top of the Linux kernel 1610. Accordingly, the container layer 1650 may perform a capability authorization operation 1690 to implement the appropriate computing configuration with respect to the user operator 1640. Altogether, leveraging post-compilation configuration management with respect to a stream computing application may be associated with benefits such as data security, stream computing configuration flexibility, and stream computing application performance

In addition to embodiments described above, other embodiments having fewer operational steps, more operational steps, or different operational steps are contemplated. Also, some embodiments may perform some or all of the above operational steps in a different order. In embodiments, operational steps may be performed in response to other operational steps. The modules are listed and described illustratively according to an embodiment and are not meant to indicate necessity of a particular module or exclusivity of other potential modules (or functions/purposes as applied to a specific module).

In the foregoing, reference is made to various embodiments. It should be understood, however, that this disclosure is not limited to the specifically described embodiments. Instead, any combination of the described features and elements, whether related to different embodiments or not, is contemplated to implement and practice this disclosure. Many modifications and variations may be apparent to those of ordinary skill in the art without departing from the scope and spirit of the described embodiments. Furthermore, although embodiments of this disclosure may achieve advantages over other possible solutions or over the prior art, whether or not a particular advantage is achieved by a given embodiment is not limiting of this disclosure. Thus, the described aspects, features, embodiments, and advantages are merely illustrative and are not considered elements or limitations of the appended claims except where explicitly recited in a claim(s).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Embodiments according to this disclosure may be provided to end-users through a cloud-computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud-computing resources are provided to a user on a pay-per-use basis, where users are charged only for the computing resources actually used (e.g., an amount of storage space used by a user or a number of virtualized systems instantiated by the user). A user can access any of the resources that reside in the cloud at any time, and from anywhere across the Internet. In context of the present disclosure, a user may access applications or related data available in the cloud. For example, the nodes used to create a stream computing application may be virtual machines hosted by a cloud service provider. Doing so allows a user to access this information from any computing system attached to a network connected to the cloud (e.g., the Internet).

Embodiments of the present disclosure may also be delivered as part of a service engagement with a client corporation, nonprofit organization, government entity, internal organizational structure, or the like. These embodiments may include configuring a computer system to perform, and deploying software, hardware, and web services that implement, some or all of the methods described herein. These embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to exemplary embodiments, other and further embodiments of the invention may be devised without departing from the basic scope thereof, and the scope thereof is determined by the claims that follow. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. “Set of,” “group of,” “bunch of,” etc. are intended to include one or more. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of exemplary embodiments of the various embodiments, reference was made to the accompanying drawings (where like numbers represent like elements), which form a part hereof, and in which is shown by way of illustration specific exemplary embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. But, the various embodiments may be practiced without these specific details. In other instances, well-known circuits, structures, and techniques have not been shown in detail in order not to obscure embodiments.

What is claimed is:

1. A computer-implemented method for post-compilation configuration management in a stream computing environment to process a stream of tuples, the method comprising:
detecting, pertaining to a post-compilation phase in the stream computing environment, an escalation request that relates to a requested computing configuration for a process in the stream computing environment;
determining, based on the requested computing configuration for the process in the stream computing environment, an appropriate computing configuration for the process in the stream computing environment; and
establishing, using a containerization technique, the appropriate computing configuration for the process in the stream computing environment.

2. The method of claim 1, further comprising:
partitioning, using the containerization technique, a stream computing application which has a set of computing objects to have both:
a first subset of the set of computing objects related to a privileged-segment, and
a second subset of the set of computing objects related to a user-segment; and
establishing, pertaining to a run-time phase of the stream computing application in the stream computing environment, the appropriate computing configuration for the process in the stream computing environment.

3. The method of claim 1, further comprising:
detecting, pertaining to the post-compilation phase in the stream computing environment, the escalation request that relates to a requested computing capability for the process in the stream computing environment;
determining, based on the escalation request, an appropriate computing capability for the process in the stream computing environment; and
establishing, using the containerization technique, the appropriate computing capability for the process in the stream computing environment.

4. The method of claim 1, further comprising:
detecting, pertaining to the post-compilation phase in the stream computing environment, the escalation request that relates to a requested computing permission for the process in the stream computing environment;
determining, based on the escalation request, an appropriate computing permission for the process in the stream computing environment; and
establishing, using the containerization technique, the appropriate computing permission for the process in the stream computing environment.

5. The method of claim 1, further comprising:
detecting, pertaining to the post-compilation phase in the stream computing environment, the escalation request that relates to a requested file system access authority for the process in the stream computing environment;
determining, based on the escalation request, an appropriate file system access authority for the process in the stream computing environment; and
establishing, using the containerization technique, the appropriate file system access authority for the process in the stream computing environment.

6. The method of claim 1, further comprising:
detecting, pertaining to the post-compilation phase in the stream computing environment, the escalation request that relates to a requested physical resource utilization authority for the process in the stream computing environment;
determining, based on the escalation request, an appropriate physical resource utilization authority for the process in the stream computing environment; and
establishing, using the containerization technique, the appropriate physical resource utilization authority for the process in the stream computing environment.

7. The method of claim 1, further comprising:
detecting, pertaining to the post-compilation phase in the stream computing environment, the escalation request that relates to a requested encrypted-data access authority for the process in the stream computing environment;
determining, based on the escalation request, an appropriate encrypted-data access authority for the process in the stream computing environment; and
establishing, using the containerization technique, the appropriate encrypted-data access authority for the process in the stream computing environment.

8. The method of claim 1, further comprising:
detecting, pertaining to the post-compilation phase in the stream computing environment, the escalation request that relates to a requested computing resource allotment for the process in the stream computing environment;
determining, based on the escalation request, an appropriate computing resource allotment for the process in the stream computing environment; and
establishing, using the containerization technique, the appropriate computing resource allotment for the process in the stream computing environment.

9. The method of claim 1, further comprising:
structuring the containerization technique to include an operating-system-level virtualization for running multiple isolated systems on a control host using a single kernel; and
establishing, using the operating-system-level virtualization for running multiple isolated systems on the control host using the single kernel, the appropriate computing configuration for the process in the stream computing environment.

10. The method of claim 1, further comprising:
structuring, for the process in the stream computing environment, the appropriate computing configuration to have a validity window; and
establishing, for utilization within the validity window, the appropriate computing configuration for the process in the stream computing environment.

11. The method of claim 10, further comprising:
sensing a window invalidation event which indicates a conclusion of the validity window; and
establishing, for utilization outside-of the validity window, a distinct computing configuration for the process in the stream computing environment.

12. The method of claim 1, further comprising:
introducing, in the stream computing environment, a container layer between a set of user processes and an operating system.

13. The method of claim 1, further comprising:
introducing, in the stream computing environment, a containerization engine to interface with an authentication management engine to manage one or more computing configurations of a stream computing application.

14. The method of claim 13, further comprising:
introducing, in the stream computing environment, a shim to manage the escalation request; and
analyzing, in the stream computing environment in an external fashion with respect to the process, the escalation request.

15. The method of claim 1, further comprising:
establishing, using a resource acquisition is initialization (RAII) technique in advance of running a set of processing elements to process the stream of tuples, the appropriate computing configuration in the stream computing environment; and
running, in response to establishing the appropriate computing configuration in the stream computing environment, the set of processing elements using the appropriate computing configuration in the stream computing environment to process the stream of tuples.

16. The method of claim 1, further comprising:
executing, in a dynamic fashion to streamline post-compilation configuration management in the stream computing environment, each of:
the detecting, the determining, and the establishing.

17. The method of claim 1, further comprising:
executing, in an automated fashion without user intervention, each of:
the detecting, the determining, and the establishing.

18. The method of claim 1, further comprising:
receiving the stream of tuples to be processed by a set of processing elements which operates on a set of compute nodes in the stream computing environment having the appropriate computing configuration; and
processing, using the set of processing elements operating on the set of compute nodes in the stream computing environment having the appropriate computing configuration, the stream of tuples.

19. A system for post-compilation configuration management in a stream computing environment to process a stream of tuples, the system comprising:
a memory having a set of computer readable computer instructions, and
a processor for executing the set of computer readable instructions, the set of computer readable instructions including:
detecting, pertaining to a post-compilation phase in the stream computing environment, an escalation request that relates to a requested computing configuration for a process in the stream computing environment;
determining, based on the requested computing configuration for the process in the stream computing environment, an appropriate computing configuration for the process in the stream computing environment; and
establishing, using a containerization technique, the appropriate computing configuration for the process in the stream computing environment.

20. A computer program product for post-compilation configuration management in a stream computing environment to process a stream of tuples, the computer program product comprising a computer readable storage medium having program instructions embodied therewith, wherein the computer readable storage medium is not a transitory signal per se, the program instructions executable by a processor to cause the processor to perform a method comprising:
detecting, pertaining to a post-compilation phase in the stream computing environment, an escalation request that relates to a requested computing configuration for a process in the stream computing environment;
determining, based on the requested computing configuration for the process in the stream computing environment, an appropriate computing configuration for the process in the stream computing environment; and
establishing, using a containerization technique, the appropriate computing configuration for the process in the stream computing environment.
